(19) United States
(12) Patent Application Publication
(10) Pub. No.: US 2026/0205463 A1
(43) Pub. Date: Jul. 16, 2026

(54) SYSTEMS AND METHODS OF COMMUNICATION NETWORK PROTOCOL STACK

(71) Applicant: Huawei Technologies Co., Ltd., Shenzhen (CN)

(72) Inventor: Wei Tan, Shenzhen (CN)

(21) Appl. No.: 19/547,024

(22) Filed: Feb. 23, 2026

Related U.S. Application Data
(63) Continuation of application No. PCT/CN2023/115673, filed on Aug. 30, 2023.

(51) Int. Cl. H04L 9/40

(52) U.S. Cl. CPC H04L 63/104

(57) ABSTRACT

Apparatus, methods and systems of communication network protocol stack may be provided according to one or more aspects. According to an aspect, a method may be provided for joining a blockchain network. The method includes sending, by a first entity (FE) to a second entity (SE), a request message to join a group associated with a blockchain. The request message may include one or more of: a player identifier (ID) identifying the FE, a group ID identifying the blockchain, a group contract ID identifying a set of instructions to be followed, a read permission, or a write permission. The method may further include receiving, by the FE from the SE, a response message indicating that the FE is verified to join the group, the response message including the group ID and the group contract ID.

### CROSS-REFERENCE TO RELATED APPLICATION

This application is a continuation of International Patent Application No. PCT/CN2023/115673, filed on Aug. 30, 2023, the disclosure of which is hereby incorporated by reference in its entirety.

### TECHNICAL FIELD

The present disclosure pertains to the field of network communications, and in particular to systems and methods of communication network protocol stack.

### BACKGROUND

6G is the next generation of wireless technology that is expected to bring significant improvements over 5G. 6G is expected to offer faster data rates, lower latency, higher reliability, greater energy efficiency, and more secure and resilient networks. However, current 5G network faces several limitations that need to be addressed to enable development of 6G network. One major limitation is the lack of security and privacy measures, which can put sensitive data at risk. 5G networks are vulnerable to various types of security threats, such as eavesdropping, and data breaches. Another limitation is the centralized architecture of the 5G network, which can lead to issues with scalability and reliability as the number of connected devices increases. With the increasing number of connected devices and the exponential growth of data traffic, scalability is becoming a major challenge as it affects network performance such as response time and throughput. Accordingly, improvements in network technologies and architecture are desirable.

Therefore, there is a need for systems and methods of communication network protocol stack that obviates or mitigates one or more limitations of the prior art.

This background information is provided to reveal information believed by the applicant to be of possible relevance to the present application. No admission is necessarily intended, nor should be construed, that any of the preceding information constitutes prior art against the present application.

### SUMMARY

Apparatus, methods and systems of communication network protocol stack may be provided according to one or more aspects. According to an aspect, a method may be provided for joining a blockchain network. The method includes sending, by a first entity (FE) to a second entity (SE), a request message to join a group associated with a blockchain. The request message may include one or more of: a player identifier (ID) identifying the FE, a group ID identifying the blockchain, a group contract ID identifying a set of instructions to be followed, read permission, and write permission. The method may further include receiving, by the FE from the SE, a response message indicating that the FE is verified to join the group, the response message including the group ID and the group contract ID.

Sending the request message may include sending, by the FE to the SE, the request message via a data consensus protocol (DCP) layer of a control plane protocol stack associated with the FE. Receiving the response message may include receiving, by the FE from the SE, the response message via the DCP layer.

The FE may be a user equipment (UE) and the SE may be an access node (AN). Where the FE is an access node (AN) and the SE is a user equipment (UE), the method may further includes sending, by the FE to a second AN, a second request message to join the group associated with the blockchain. The second request message may include one or more of: the player ID identifying the FE, the group ID identifying the blockchain, the group contract ID identifying the set of instructions to be followed, the read permission and write permission. Where the FE is an access node (AN) and the SE is a user equipment (UE), the method may further includes receiving, by the FE from the second AN, a second response indicating that the second AN has verified the FE to join the group.

The method may further include receiving, by the FE from the second AN, a third response message associated with a second UE and indicating that the second UE has verified the FE.

According to another aspect, another method may be provided for joining a blockchain network. The method includes receiving, by a first entity (FE) from a second entity (SE), a request message to join a group associated with a blockchain. The request message may include one or more of: a player identifier (ID) identifying the SE, a group ID identifying the blockchain, a group contract ID identifying a set of instructions to be followed, read permission, and write permission. The method may further include verifying, by the FE, one or both of: the player ID and the group ID. The method may further include sending, by the FE to the SE, a response message indicating that the SE is verified to join the group.

Receiving the request message may include receiving, by the FE from the SE, the request message via a data consensus protocol (DCP) layer of a control plane protocol stack associated with the FE. Sending the response message may include sending, by the FE to the SE, the response message via the DCP layer.

The FE may be a user equipment (UE) and the SE may be an access node (AN). Where the FE is an access node (AN) and the SE may be a user equipment (UE), the method may further include updating, by the FE, one or more parameters of the SE based on the request message and sending, by the FE to a second AN, a second request message based on the request message. The second request message may include one or more of: the player ID, the group ID, the group contract ID, the read permission, and the write permission. Where the FE is an access node (AN) and the SE may be a user equipment (UE), the method may further include receiving, by the FE from the second AN, a second response message indicating that the second AN has verified the SE to join the group. Where the FE is an access node (AN) and the SE may be a user equipment (UE), the method may further include receiving, by the FE from the second AN, a third response message associated with a second UE and indicating that second UE has updated one or more parameters of the SE associated with the blockchain.

According to another aspect, another method may be provided for joining a blockchain network. The method may include receiving, by an access node (AN) from a second AN, a request message associated with a first entity (FE) and requesting to join a group associated with a blockchain. The request message may include one or more of: a player identifier (ID) identifying the FE, a group ID identifying the blockchain, a group contract ID identifying a set of instructions to be followed, read permission and write permission. The method may further include verifying, by the AN, one or both of: the player ID and the group ID. The method may further include sending, by the AN to the second AN, a response message indicating that the FE is verified to join the group.

Where the FE is a user equipment (UE), the method further may include updating, by the AN, one or more parameters of the FE based on the request message, and sending, by the AN to a second UE, a second request message based on the request message. The second request message may include one or more of: the player ID, the group ID, the group contract ID, the read permission, and the write permission. Where the FE is a user equipment (UE), the method may further include receiving, by the AN from the second UE, a second response message indicating that the second UE has updated one or more parameters of the FE associated with the blockchain. Where the FE is a user equipment (UE), the method may further include sending, by the AN to the second AN, the second response message.

Where the FE is the second AN, the method may further include updating, by the AN, one or more parameters of the FE based on the request message, and sending, by the AN to a second UE, a second request message based on the request message. The second request message may include one or more of: the player ID, the group ID, the group contract ID, the read permission, and the write permission. Where the FE is the second AN, the method may further include receiving, by the AN from the second UE, a second response message indicating that the second UE has verified the FE to join the group. Where the FE is the second AN, the method may further include sending, by the AN to the second AN, the second response message.

According to an aspect, another method may be provided for accessing a blockchain. The method may include sending, by a user equipment (UE) to an access node (AN), a request message to access the blockchain. The request message may include one or more of: a player identifier (ID) identifying the UE, a group ID identifying the blockchain, a group contract ID identifying a set of instructions to be followed, read permission and write permission. The method may further include receiving, by the UE form the AN, a second request message to configure a consensus mode for use on the blockchain. The method may further include sending, by the UE to the AN, a response message including one or more of: the player ID, the group ID and the consensus mode. The method may further include configuring, by the UE, the consensus mode.

According to another aspect, another method may be provided for accessing a blockchain. The method may include receiving, by an access node (AN) from a user equipment, a request message to access the blockchain. The request message may include one or more of: a player identifier (ID) identifying the UE, a group ID identifying the blockchain, a group contract ID identifying a set of instructions to be followed, read permission and write permission. The method may further include sending, by the AN to the UE, a second request message to configure a consensus mode for use on the blockchain. The method may further include receiving, by the AN from the UE, a response message including one or more of: the player ID, the group ID and the consensus mode.

The method may further include sending, by the AN to a second AN, the response message. The method may further include sending, by the AN to an access and mobility management function (AMF), the request message to access the blockchain. The method may further include receiving, by the AN from the AMF, a request message to update a context of the UE. The method may further include sending, by the AN to the AMF, a response message including one or more of: the player ID, the group ID and the consensus mode.

According to another aspect, another method may be provided for accessing a blockchain. The method may include receiving, by an access and mobility management function (AMF) from an access node (AN), a request message to access the blockchain. The request message may include one or more of: a player identifier (ID) identifying a user equipment (UE), a group ID identifying the blockchain, a group contract ID identifying a set of instructions to be followed, read permission and write permission. The method may further include verifying, by the AMF, one more of: the player ID and the group ID. The method may further include sending, by the AMF to the AN, a request message to update a context of the UE. The method may further include receiving, by the AMF from the AN, a response message including one or more of: the player ID, the group ID and a consensus mode.

According to another aspect, another method may be provided for establishing a connection to a blockchain network. The method may include sending, by a user equipment (UE) to an access node (AN), a request message to establish the connection to the blockchain network. The request message may include one or more of: a player identifier (ID) identifying the UE, a group ID identifying a blockchain, and a consensus mode. The method may further include receiving, by the UE from the AN, a response message indicating that the consensus mode is configured. The method may further include sending, by the UE to the AN, a complete message indicating that the connection is established.

According to an aspect, another method may be provided for establishing a connection to a blockchain network. The method may include receiving, by an access node (AN) from a user equipment (UE), a request message to establish the connection to the blockchain network. The request message may include one or more of: a player identifier (ID) identifying the UE, a group ID identifying a blockchain, and a consensus mode. The method may further include configuring, by the AN, the consensus mode based on the request message. The method may further include sending, by the AN to the UE, a response message indicating that the consensus mode is configured.

The method may further include receiving, by the AN from the UE, a complete message indicating that the connection is established. The method may further include sending, by the AN to a second AN, a second complete message including one or more of: the player ID, the group ID, and the consensus mode.

According to another aspect, another method for establishing a connection to a blockchain network may be provided. The method includes receiving, by an access node (AN) from a user equipment (UE), a request message to establish the connection to the blockchain network. The request message may include one or more of: a player identifier (ID) identifying the UE, a group ID identifying a blockchain, and a consensus mode. The method may further include processing, by the AN, the request message to determine that the connection cannot be established. The method may further include sending, by the AN to the UE, a reject message indicating that the connection cannot be established.

According to an aspect, another method for releasing a connection from a blockchain network may be provided. The method include sending, by a first entity (FE) to a second entity (SE), a request message to release the connection from the blockchain network. The request message may include one or more of: a player identifier (ID) identifying a user equipment (UE) associated with the connection, a group ID identifying a blockchain of the blockchain network. The method may further include receiving, by the FE from the SE, a response message indicating that a context of the UE is released. The method may further include releasing, by the FE, the context of the UE.

Where the FE is the UE and the SE is an access node (AN), the method may further include sending, by the FE to the SE, a release complete message indicating that context of the UE is released.

Where the FE is an access node (AN) and the SE is the UE, the method may further include sending, by the FE to a second AN, a second request message to release the connection from the blockchain network. The second request message may include one or more of: the player ID and the group ID. The method may further include receiving, by the FE from the second AN, a second release complete message indicating that the context of the UE, at the second AN, is released.

According to an aspect, another method for releasing a connection from a blockchain network may be provided. The method includes receiving, by a first entity (FE) from a second entity (SE), a request message to release the connection from the blockchain network. The request message may include one or more of: a player identifier (ID) identifying a user equipment (UE) associated with the connection, a group ID identifying a blockchain of the blockchain network. The method may further include verifying, by the FE, one or more of: the player ID and the group ID. The method may further include releasing, by the FE, a context of the UE based on the request message. The method may further include sending, by the FE to the SE, a response message indicating that the context of the UE, at the FE, is released. The FE may be the UE and the SE may be an access node (AN).

Where the FE is an access node (AN) and the SE is a second AN, the method may further include receiving, by the FE from the SE, a release complete message indicating that the context of the UE, at the SE, is released. The method may further include sending, by the FE to a second AN, a second request message to release the connection from the blockchain network. The second request message may include one or more of: the player ID and the group ID. The method may further include receiving, by the FE from the second AN, a second release complete message indicating that the context of the UE, at the second AN, is released.

According to an aspect, a method for sending data using a blockchain may be provided. The method includes sending, by a first entity (FE) to a second entity (SE), a request message for sending data using the blockchain. The request message may include one or more of: a player identifier (ID) identifying the FE, a group ID identifying the blockchain. The method may further include receiving, by the FE from the SE, a response message indicating that FE is verified for sending the data. The method may further include sending, by the FE to the SE, the data.

Sending the data may include sending, by the FE to the SE, the data via a data consensus protocol (DCP) layer of a user plane protocol stack associated with the FE. The data includes a DCP protocol data unit including a DCP header and user plane data. The DCP header may include a blockchain storage indication (BSI) field indicating whether data is to be stored on the blockchain. The DCP header may further include a blockchain storage method indication (BMI) field indicating to store the data on the blockchain based on one of: full data, abstract data or data link. The DCP header may further include a blockchain flow identifier (BFI) field indicating that data includes one or more of: video, audio, image, and text. The FE may be a user equipment (UE) and the SE may be an access node (AN).

Where the FE is an access node (AN) and the SE is a user equipment (UE), the method may further include sending, by the FE to a second AN, a second request message for sending the data, the second request message including one or more of: the player ID and the group ID. The method may further include receiving, by the FE from the second AN, a second response message indicating that the second AN has verified the FE for sending the data. The method may further include sending, by the FE to the SE, the second response message.

The method may further include receiving, by the FE from the second AN, a third response message associated with a second UE and indicating that the second UE has verified the FE for sending the data. The method may further include sending, by the FE to the SE, the third response message. The method may further include sending, by the FE to the second AN, the consensus data.

According to another aspect, another method for sending data using a blockchain may be provided. The method includes receiving, by a first entity (FE) from a second entity (SE), a request message for sending the data. The request message may include one or more of: a player identifier (ID) identifying the SE, a group ID identifying a blockchain. The method may further include verifying, by the FE, one or both of: the player ID and the group ID. The method may further include sending, by the FE to the SE, a response message indicating that the SE is verified to send the data.

The method may further include receiving, by the FE from the SE, the data via a data consensus protocol (DCP) layer of a user plane protocol stack associated with the FE. The FE may be a user equipment (UE) and the SE may be an access node (AN).

The data may include a DCP protocol data unit including a DCP header and user plane data. The DCP header may include a blockchain storage indication (BSI) field indicating whether data is to be stored on the blockchain. The DCP header may further include a blockchain storage method indication (BMI) field indicating to store the data on the blockchain based on one of: full data, abstract data or data link. The DCP header may further include a blockchain flow identifier (BFI) field indicating that data includes one or more of: video, audio, image, and text.

Where the FE is an access node (AN) and the SE is a user equipment (UE), the method may further include updating, by the FE, one or more parameters of the SE based on the request message. The method may further include sending, by the FE to a second AN, a second request message for sending the data, the second request message including one or more of: the player ID and the group ID. The method may further include receiving, by the FE from the second AN, a second response message indicating that the second AN has verified the SE for sending the data using the blockchain. The method may further include receiving, by the FE from the second AN, a third response message associated with a second UE and indicating that second UE has verified the SE for sending the data using the blockchain.

The method may further include sending, by the FE to the second AN, the data via a data consensus protocol (DCP) layer of a user plane protocol stack associated with the FE.

According to another aspect, another method for sending data using a blockchain may be provided. The method includes receiving, by an access node (AN) from a second AN, a request message for sending the data. The request message may include one or more of: a player identifier (ID) identifying a first network element (FE), a group ID identifying the blockchain. The method may further include verifying, by the AN, one or both of: the player ID and the group ID. The method may further include sending, by the AN to the second AN, a response message indicating that the FE is verified to send the data using the blockchain.

The method may further include receiving, by the AN from the second AN, the data via a data consensus protocol (DCP) layer of a user plane protocol stack associated with the AN. The data includes a DCP protocol data unit including a DCP header and user plane data. The DCP header may include a blockchain storage indication (BSI) field indicating whether data is to be stored on the blockchain. The DCP header may further include a blockchain storage method indication (BMI) field indicating to store the data on the blockchain based on one of: full data, abstract data or data link. The DCP header may further include a blockchain flow identifier (BFI) field indicating that data includes one or more of: video, audio, image, and text.

Where the FE is a user equipment (UE) or the second AN, the method may further include updating, by the AN, one or more parameters of the FE based on the request message. The method may further include sending, by the AN to a second UE, a second request message for sending the data, the second request message including one or more of: the player ID and the group ID. The method may further include receiving, by the AN from the second UE, a second response message indicating that the second UE has verified the FE for sending the data using the blockchain. The method may further include sending, by the AN to the second AN, a third response message based on the second response message. The method may further include sending, by the AN to the second UE, the data via a data consensus protocol (DCP) layer of a user plane protocol stack associated with the AN.

According to another aspect, an apparatus is provided. The apparatus includes modules configured to perform one or more of the methods and systems described herein.

According to one aspect, an apparatus is provided, where the apparatus includes: a memory, configured to store a program; a processor, configured to execute the program stored in the memory, and when the program stored in the memory is executed, the processor is configured to perform one or more of the methods and systems described herein.

According to another aspect, a computer readable medium is provided, where the computer readable medium stores program code executed by a device and the program code is used to perform one or more of the methods and systems described herein.

According to one aspect, a chip is provided, where the chip includes a processor and a data interface, and the processor reads, by using the data interface, an instruction stored in a memory, to perform one or more of the methods and systems described herein.

Other aspects of the disclosure provide for apparatus, and systems configured to implement the methods according to the first aspect disclosed herein. For example, wireless stations and access points can be configured with machine readable memory containing instructions, which when executed by the processors of these devices, configures the device to perform one or more of the methods and systems described herein.

Embodiments have been described above in conjunction with aspects of the present application upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present application will become apparent from the following detailed description, taken in combination with the appended drawings, in which:

FIG. 1 illustrates a prior art control plane protocol stack.

FIG. 2 illustrates control protocol plane stack, according to an aspect.

FIG. 3 illustrates user plane protocol stack, according to an aspect.

FIG. 4 illustrates a DCP protocol data unit (PDU), according to an aspect.

FIG. 5 illustrates a bit field table for a blockchain storage indication (BSI) field, according to an aspect.

FIG. 6 illustrates a bit field table for a blockchain storage method indication (BMI) field, according to an aspect.

FIG. 7 illustrates a bit field table for a blockchain flow ID (BFI) field, according to an aspect.

FIG. 8 illustrates a Layer 2 data flow of a network node, according to an aspect.

FIG. 9 illustrates a UE-initiated method for broadcasting blockchain configuration information, according to an aspect.

FIG. 10 illustrates an xNB-initiated method for broadcasting blockchain configuration information, according to an aspect.

FIG. 11 illustrates a method for verifying an initial access of a blockchain node on the core network, according to an aspect.

FIG. 12 illustrates a method for verifying an initial access of a blockchain without involving the core network, according to an aspect.

FIG. 13 illustrates a method for establishing a DCP connection on a blockchain node, according to an aspect.

FIG. 14 illustrates a method for rejecting a DCP connection establishment request, according to an aspect.

FIG. 15 illustrates a UE-initiated method for DCP connection release, according to an aspect.

FIG. 16 illustrates a network-initiated method for releasing a DCP connection, according to an aspect.

FIG. 17 illustrates a UE-initiated method for transmission of block consensus data, according to an aspect.

FIG. 18 illustrates an xNB-initiated method for transmission of block consensus data, according to an aspect.

FIG. 19 illustrates an apparatus that may perform any or all of operations of the above methods and features explicitly or implicitly described herein, according to different aspects of the present disclosure.

It will be noted that throughout the appended drawings, like features are identified by like reference numerals.

### DETAILED DESCRIPTION OF THE ILLUSTRATIVE EMBODIMENTS

Apparatus, methods and systems of communication network protocol stack may be provided according to one or more aspects. According to an aspect, a method may be provided for joining a blockchain network. For example, method 900 is a UE-initiated procedure for joining a group associated with a blockchain (e.g., a blockchain network). According to method 900, a UE may request to join a blockchain network by sending a request message that includes one or more of a player ID (as defined herein), a group ID (as defined herein), a group contract ID (as defined herein) and read/write permission. An xNB may verify the UE based on the request and send a response indicating that the UE is verified for joining the blockchain network. Method 900 is further described herein. Method 1000 is an x-NB-initiated procedure for joining a group, as described herein.

According to another aspect, a method 1100 for accessing a blockchain network may be provided. According to method 1100, a UE may send a request for a connection (e.g., a DCP connection as described herein) and include in the request one or more of: player ID, group ID, group contract ID and read and write permission. An xNB that receives the request my forward the request to an AMF for verification. Once verified, as per method 1100, the xNB may request the UE to configure a consensus mode for the blockchain for which the UE is requesting a DCP connection. The UE may then configure the consensus mode for use on the blockchain and send a complete message to the xNB. Method 1100 is further described herein. According to another aspect, method 1200 illustrates another method for accessing a blockchain without involving the AMF as described herein.

According to another aspect, a method 1300 for establishing a connection to a blockchain network may be provided. According to method 1300, a UE may send a request to establish a connection to a blockchain network and include in the request one or more of: player ID, group ID and consensus node for use on a blockchain of the blockchain network. An xNB receiving the request may verify the UE and the request. The xNB may further configure the received consensus mode. xNB may further send a response message to the UE indicating that the consensus mode is configured. The UE may then send a setup complete message to xNB indicating that the DCP connection is established. The xNB may further forward the setup complete message to one or more neighboring xNBs. Method 1300 is further described herein. According to an aspect, a method 1400 may be provided for rejecting a request to establishing a connection to a blockchain network. As described herein, a request to establish a connection may rejected based on load balancing for example. Thus, when a request to establish a connection is received by an xNB, xNB may determine that the connection cannot be handled due to load balancing or other applicable reasons. xNB may then send a rejection response to the requesting network entity (e.g., UE). Method 1400 is further described herein.

According to another aspect, a method 1500 for releasing a connection from a blockchain network may be provided. According to method 1500, a UE may request that a connection to a blockchain network be released and include in the request one or more of player ID and group ID. The xNB that receives the request may verify the request and release the connection resources (DCP context). The xNB may then respond to UE indicating release of the connection. The UE may then release the connection resources and send a release complete message back to the xNB. Method 1500 is further described herein. Method 1600 is another method for releasing a connection from a blockchain network. In method 1600, the network (e.g., an xNB) may initiate the release procedure of a connection as described herein.

According to another aspect, a method 1700 for sending data using or on a blockchain may be provided. According to method 1700, a network entity (e.g., a UE) that wants to send data on the blockchain (e.g., consensus data), the network entity sends a request to send the data and include in the request one or both of player ID and group ID. Each blockchain node of the blockchain network may verify the request for sending the data as described herein. After which, the network entity may send the data (consensus data). Method 1700 is further described herein. Method 1800 is another method for sending consensus data, in which the network entity is xNB, as described herein.

The 6G communication network is expected to span space and sea and include multiple players. The actual network carrier includes low and medium-altitude platforms such as satellite networks and drones, cellular networks, Internet of Vehicles (IoVs), IoT networks, and surface and underwater networks.

The 6G network expands the forms and functions of 5G communication terminals. 6G terminals include, but are not limited, to vehicles, cellular network terminals (converging satellite terminal functions), drones, and IoT. The capabilities of 6G terminals are expected to surpass those of 5G terminals due to advancements that 6G is anticipated to provide.

The unique consensus and intelligent contract mechanism of blockchain brings new opportunities for multi-party trust in decentralized networks and may be one of the potential candidate technologies for 6G. According to the National Institute of Standards and Technology (NIST) communication service provider (CSP) standard report, trustworthiness includes security, privacy, reliability, and resilience. In the future, 6G ultra-large-scale access and distributed networking mode, fast mutual trust and effective recording and review of network behavior and operation data are inevitable requirements. Currently, blockchain technology may support these security requirements. Communication networks and blockchains can be independently expanded, evolved, and developed without tightly coupled interactions and gaps. New trusted technology systems such as wireless communication networks and blockchains will bring more security assurance methods and more flexible security mechanisms to 6G. Adding independent security capabilities to enable wireless communication networks and two-way blockchain/trusted technologies is key to meeting this need.

A blockchain may generate and store data in blocks (blocks) and connect the blocks in chronological order into a chained (chain) data structure. All nodes participate in data verification, storage, and maintenance of the blockchain system. The creation of a new block must be confirmed by consensus and broadcasted to all nodes for network-wide synchronization. After that, the block cannot be changed or deleted.

As a new type of decentralized distributed ledger, blockchain’s unique consensus and smart contract mechanism bring new opportunities for multi-party joint network trustworthiness in decentralized networks, making it one of the potential candidate technologies for 6G. According to the NIST ® CSP standardized report, trust (trusted) includes security, privacy, reliability, and resilience. In the future 6G ultra-large-scale access and decentralized networking mode, it is inevitable to quickly realize mutual trust and effectively record and review network behavior data and network operation data. Blockchain is currently the most likely technology to meet these trustworthy requirements.

The communication network and blockchain have developed their respective technical lines, and there is no tight coupling interaction and fault. New trusted technology systems such as connecting wireless communication networks and blockchain may bring more security assurance methods and more flexible security mechanism combinations for 6G.

According to an aspect, the 6G communication network and communication terminals may be combined with the blockchain to allow for improved trustworthiness. The 6G communication network may be deeply involved across industries and multiple players, rather than limited to the characteristics of a single operator. Therefore, the 6G communication network may require a multi-party trust mechanism and platform. Blockchain technology has changed or transformed the trust logic of human society and may meet the needs of 6G communication networks. As may be appreciated, 6G communication network terminals are an important part of supporting 6G service applications. The forms and functions of 6G communication network terminals have changed greatly. For example, the computing and communication capabilities of vehicles have been greatly improved, meeting the basic requirements of blockchain operation. In addition, blockchains designed based on 6G networks may support more terminals.

In 5G network, blockchain and its use is outside of the network, that is, blockchain is an external distributed database of the network. In 5G, nodes are connected through a network, and each node may write data to be stored into a blockchain. Accordingly, the blockchain is not merged with the network or with the nodes of the network. Currently, blockchain is not used as an integral part of the 3GPP standards, release 16.That is, release 16 does not include a blockchain as it is used as an external database.

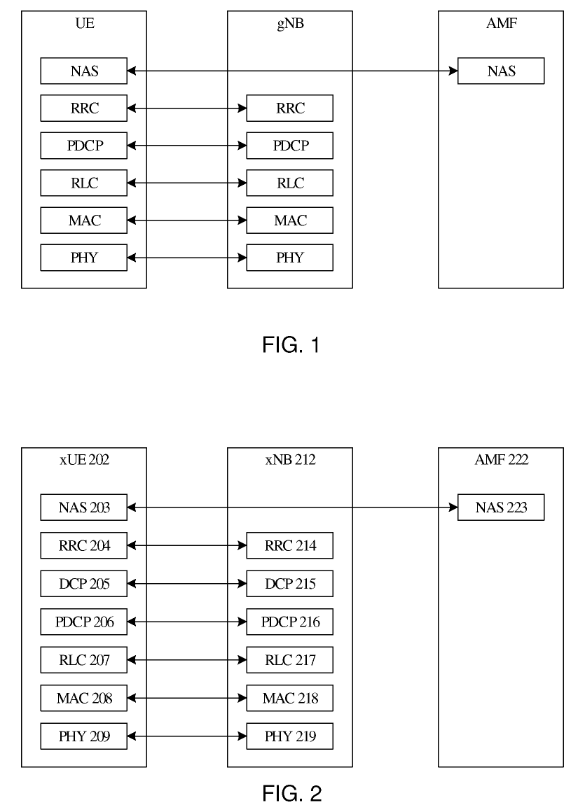

FIG. 1 illustrates a prior art control plane protocol stack. The control plane protocol stack at UE includes multiple layers, including the Non-Access Stratum (NAS), Radio Resource Control (RRC), Packet Data Convergence Protocol (PDCP), Radio Link Control (RLC), Medium Access Control (MAC), and Physical (PHY) layers. The control plane protocol stack at a RAN node (e.g., gNB) includes multiple layers of protocols including the RRC, PDCP, RLC, MAC, and PHY layers. The RRC, PDCP, RCL, MAC, MAC and PHY terminate in gNB on the network side. The NAS control protocol terminates in the Access and Mobility Management Function (AMF) on the network side.

In the prior art, a blockchain is used as an external database, and when a node in a network works as a blockchain node, the node may need to join, access, and complete interaction in an application manner by using an IP layer or a protocol above the IP layer. This may greatly increase the number of interaction nodes and the hierarchy of processing.

As may be appreciated, an increase in the number of blockchain nodes and a processing layer severely affects performance such as a network service response time and throughput. In many scenarios of 6G wireless networks, multiple players are required and have higher performance requirements, such as, in terms of delay. In addition, some 6G services are closed on the RAN side and do not need to access the core network or application server in application mode. Accordingly, a design of a blockchain in a communication network needs to be considered. According to one or more aspects described herein, a blockchain design may be provided.

Currently, a 5G protocol stack defined by 3^{rd} generation partnership project (3GPP) does not consider a case in which a blockchain is introduced to a network. To support a blockchain function in a network, a protocol stack, an interface, and an interaction process corresponding to the blockchain need to be introduced, but these contents do not exist in an existing system architecture.

Currently, the use of blockchain for communications networks (such as 5G and 6G) in the industry refers to the use of blockchain for service applications based on basic communications networks. For example, IoT applications built on 5G networks use the anti-tampering, consensus, and smart contract capabilities of blockchain. Therefore, the concept of blockchain on communications networks is a general concept. However, from a technical perspective, communications networks do not integrate blockchain capabilities (e.g., anti-tampering, consensus, and smart contract). Only by integrating or deeply integrating blockchain capabilities into the telecom network infrastructure and defining specific architecture, interfaces, and function requirements can blockchain capabilities be truly a part of the telecom network infrastructure or endogenous capabilities.

According to an aspect, blockchain may be integrated into the telecom network infrastructure to allow for blockchain capabilities be part of the telecom network infrastructure or endogenous capabilities. According to an aspect, one or more of architectures, interfaces and function requirements may be defined for integrating blockchain into the network infrastructure. Integrating blockchain into the network infrastructure may lay a foundation for the communications industry to provide such capabilities for other industries and industry cooperation.

According to an aspect, a method may be provided for converging a blockchain protocol stack in a communications network. According to an aspect, blockchain may be integrated into a communication network beyond, thereby obviating the need to use blockchain as an external database.

According to an aspect, a node in a wireless network may directly complete processes such as configuration information, protocol establishment, and consensus data exchange by using a protocol stack with a consensus function. According to an aspect, a blockchain function may be supported in one or more of a network, a protocol stack, an interface, and an interaction process.

According to an aspect, a sub-layer (a data consensus protocol) to Layer 2 of a traditional telecom network may be added. According to an aspect, one or more blockchain capabilities may be supported in a network including blockchain configuration information broadcast, node access chain confirmation, data consensus connection management, consensus algorithm selection, and consensus data transmission.

According to an aspect, a blockchain protocol stack function may be added to the traditional telecom network to integrate the two and ensure compatibility and interoperability.

According to an aspect, a Data Consensus Protocol (DCP) layer (a data consensus layer) may be added to Layer 2 of a traditional telecom network. During communication protocol interaction, one or more functions, such as blockchain configuration information broadcast, node access chain confirmation, data consensus connection management, consensus algorithm selection, and consensus data transmission may be completed.

After blockchain protocol stack is added, the communication path may be shorter since node communication may no longer need to be bypassed to application servers or external blockchains.

According to an aspect, one or more nodes of a communication network, such as a base station and a terminal, be perform one or more functions including blockchain configuration information broadcast, node access chain confirmation, data consensus connection management, consensus algorithm selection, and consensus data transmission in a communications protocol interaction process.

According to an aspect, a DCP sublayer (Data Consensus Protocol, data consensus layer) may be added to Layer 2, including a Control Plane and a User Plane.

According to an aspect, Via the DCP sublayer, a control plan functions may perform broadcasting of blockchain configuration information. For example, a control plane function, which may act as a blockchain node, may broadcast or receive blockchain configuration information. According to an aspect, a control function may allow a node to access or join the chain, and thus allow a node to become a blockchain node. According to an aspect, the control plane function may perform one or more of establishing, holding, and releasing DCP connections. According to an aspect, the control plane function may perform consensus algorithm selection.

FIG. 2 illustrates control protocol plane stack, according to an aspect. The control plane protocol stack at xUE 202 may include multiple layers including the NAS 203, RRC 204, DCP 205, PDCP 206, RLC 207, MAC 208, and PHY 209 layers. The ‘x’ in xUE (or as used with other nodes or functions) may refer to a future network such as, for example, a 6G network. Thus, xUE may refer to a future UE (e.g., a 6G UE). The control plane protocol stack at xNB 212 may include multiple layers including the RRC 214, DCP 215, PDCP 216, RLC 217, MAC 218, and PHY 219 layers. As illustrated, the RRC, PDCP, RCL, MAC, MAC and PHY layers terminate in xNB 212 on the network side. The NAS control protocol terminates in the AMF 222 on the network side. An xNB may refer to a future access node (e.g., a 6G access node).

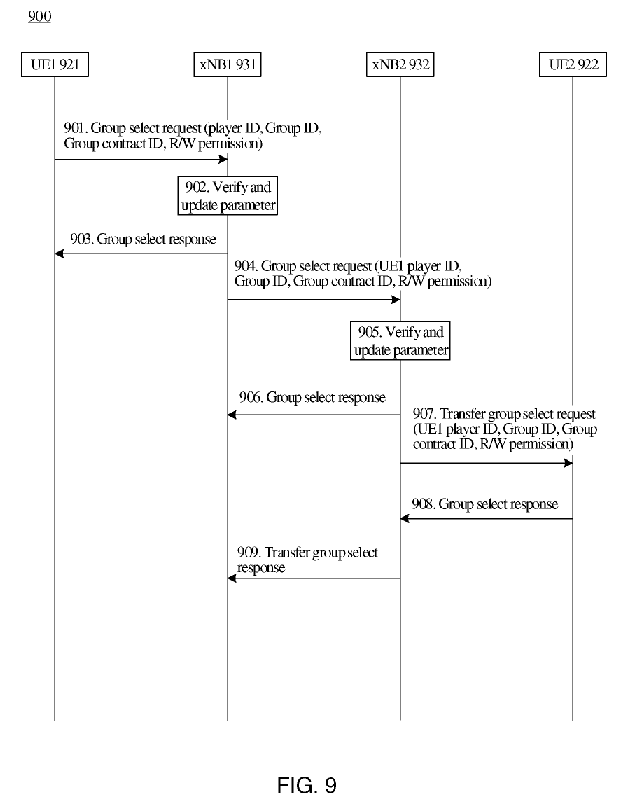

According to an aspect, communications between two network entities for performing one or more control plane functions of the DCP layer may occur at the DCP layer of the control plane protocol stack of the two network entities. For example, one or more operations involving one or more network entities in reference to FIGS. 9-18 may be done at their associated DCP layer of control plane protocol stack.

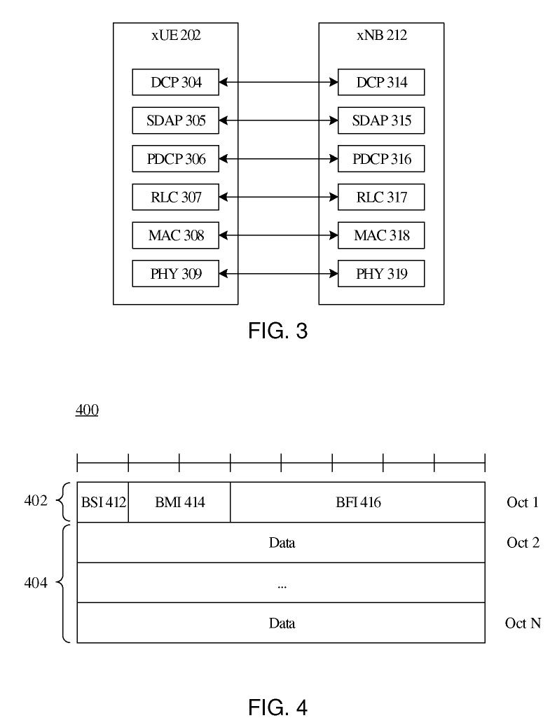

FIG. 3 illustrates user plane protocol stack, according to an aspect. The user plane protocol stack at xUE 202 may include multiple layers including DCP 304, Service Data Adaptation Protocol (SDAP) 305, PDCP 306, RLC 307, MAC 308, and PHY 309 layers. The user plane protocol stack at xNB 212 may include multiple layers including DCP 314, Service Data Adaptation Protocol (SDAP) 315, PDCP 316, RLC 317, MAC 318, and PHY 319 layers. As illustrated, the SDAP, PDCP, RLC and MAC layers may terminate in xNB on the network side.

According to an aspect, via the DCP layer, a user plane function may perform one or more of: transmitting data that requires consensus, running consensus algorithm, and reaching consensus among nodes.

The protocol stack communication process may involve one or more identifiers (IDs). The one or more IDs may include a player ID which identifies a participating entity, which may be network node contributing to the validation and writing of transactions to the blockchain. In some aspects, each participating entity may have a copy of the blockchain, which is continually updated with new transactions and validated through a consensus algorithm.

The one or more IDs may further include a group ID which may identify or be an ID of a blockchain (consortium chain). The group ID may indicate a group of nodes that contain an instance of the blockchain (may also be referred to a blockchain network). The group ID may further indicate the group of nodes that participate in the validation of transactions and that can write the transactions to the blockchain.

The one or more IDs may further include a group contract ID which may identify or be an ID of a blockchain (consortium chain) contract. The contract ID or ID of a blockchain contract may refer to a unique identifier that distinguishes one smart contract from another on the blockchain network. As may be appreciated, a smart contract can be a self-executing program that runs on the blockchain and can be used to automate the execution of one or more terms and conditions of an agreement between parties (or participating entities or nodes). Each smart contract on the blockchain may be assigned a unique identifier or contract ID, which is typically a string of characters such as a hash, that helps to identify and differentiate it from other contracts on the network. In some aspects, the contract ID may be used to interact with the contract on the blockchain, such as to initiate a transaction or to query the status of the contract. In some aspects, the contract ID may indicate one or more rules or instructions or policies that one or more participating entities may perform or follow. In some aspects, the contract ID may be associated with one or more of: group ID and player ID.

The protocol stack communication process may further involve one or both of a read permission and a write permission. The read and write permissions may respectively refer to the read and write permissions of a player in the blockchain (consortium chain). The read and write permissions may indicate how a user can handle the data on the blockchain. In some aspects, the read and write permission refers to the ability to access and modify data on the blockchain. Read permission may allow a user or entity to view the contents of the blockchain, such as transaction records or smart contract code, without being able to modify or make changes to the data. This may be necessary for verifying the accuracy of information on the blockchain. Write permission may allow a user or entity to add, modify, or delete data on the blockchain.

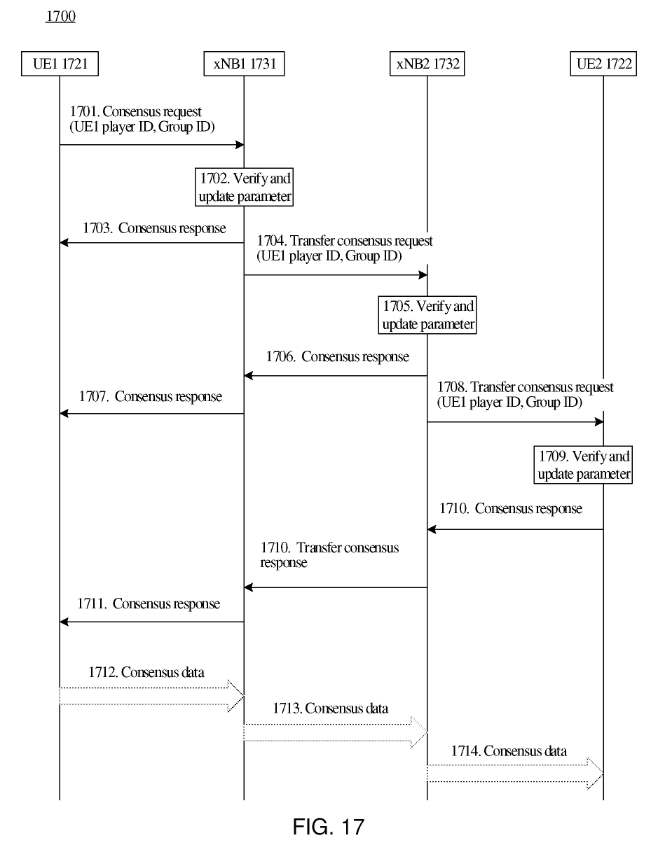

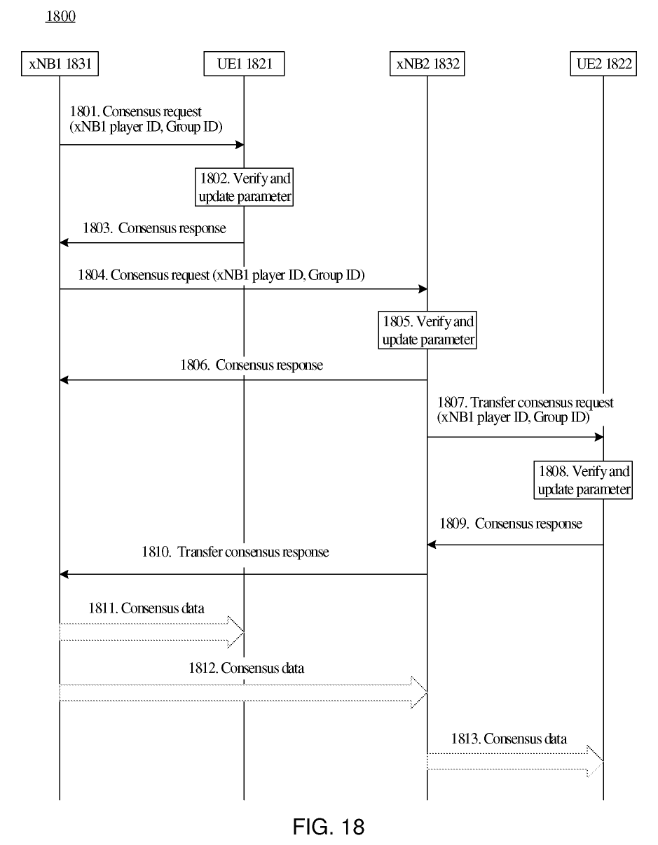

According to an aspect, communication of consensus data between two network entities may be performed at the DCP layer of the user plane protocol stack of the two network entities. For example, one or more user plane operations (e.g., transmission of consensus data) involving one or more network entities in reference to FIG. 17 and 18 may be done at their one or more associated DCP layer of the user plane protocol stack.

FIG. 4 illustrates a DCP protocol data unit (PDU), according to an aspect. The DCP PDU 400 may be used to convey one or more of: a DCP header 402 and a user plane data 404.

The DCP header 402 may indicate one or more of: a blockchain storage indication (BSI) 412, a blockchain storage method indication (BMI) 414, and a blockchain flow ID (BFI) 416.

According to an aspect, the bit ordering of the header 402 may be based on a most significant bit first ordering, where the most the most significant bit (the one with the highest place value) is at the leftmost position of the header, while the least significant bit (the one with the lowest place value) is at the rightmost position of the header. Accordingly, the left most bit is the first and most significant bit and the right most bit is the last and least significant bit.

According to an aspect, integers may be encoded in standard binary encoding for unsigned integers. In some aspects, the bits may appear ordered when read in the PDU.

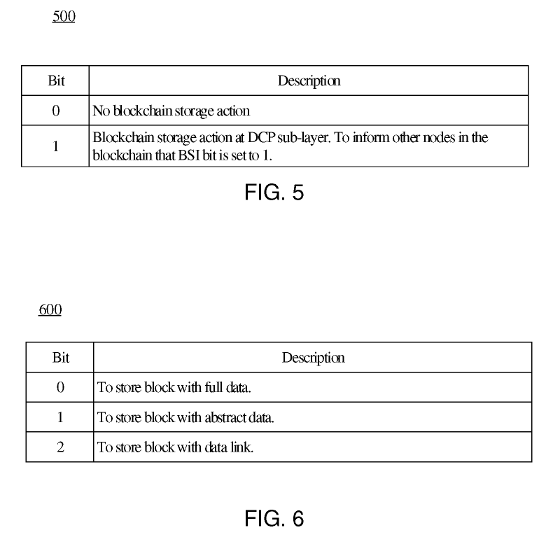

FIG. 5 illustrates a bit field table for a blockchain storage indication (BSI) field, according to an aspect. The bit field table 500 may refer to the BSI field 412 of DCP PDU 400. In some embodiments, the BSI field 412 may have a length of at least one bit. In some embodiments, a BSI bit value of 0 may indicate that no action is to be taken to store data on the blockchain (e.g., no blockchain storage action). In some embodiments, a BSI bit value of 1 may indicate that data is to be added on the blockchain (i.e., blockchain storage action) at DCP sub-layer. A BSI bit value of 1 may further indicate that other nodes in the blockchain are to be informed that BSI bit value is set to 1.

FIG. 6 illustrates a bit field table for a blockchain storage method indication (BMI) field, according to an aspect. The bit field table 600 may refer to the BMI field 414 of DCP PDU 400. In some embodiments, the BMI field 414 may have a length of at least 2 bits. In some embodiments, a BMI bit value of 0 may indicate that a block is to be stored with full data. As may be appreciated, when a block is added to the blockchain, it contains a set of transactions, metadata, and other information that is necessary to maintain the integrity and security of the blockchain. Storing a block with full data may mean that all of the information associated with that block is stored on the blockchain and is accessible to nodes on the network.

In some embodiments, a BMI bit value of 1 may indicate that a block is to be stored with abstract data. As may be appreciated, storing a block with abstract data refers to the practice of storing only essential information or metadata associated with a block on the blockchain. Abstract data can include things like transaction hash, block timestamp, and block number, which may be necessary to ensure the authenticity and validity of the blockchain without storing all of the transaction details.

In some embodiments, a BMI bit value of 2 may indicate that a block is to be stored with data link. As may be appreciated, storing a block with data links may indicate including references or links to data stored outside of the blockchain within the block itself.

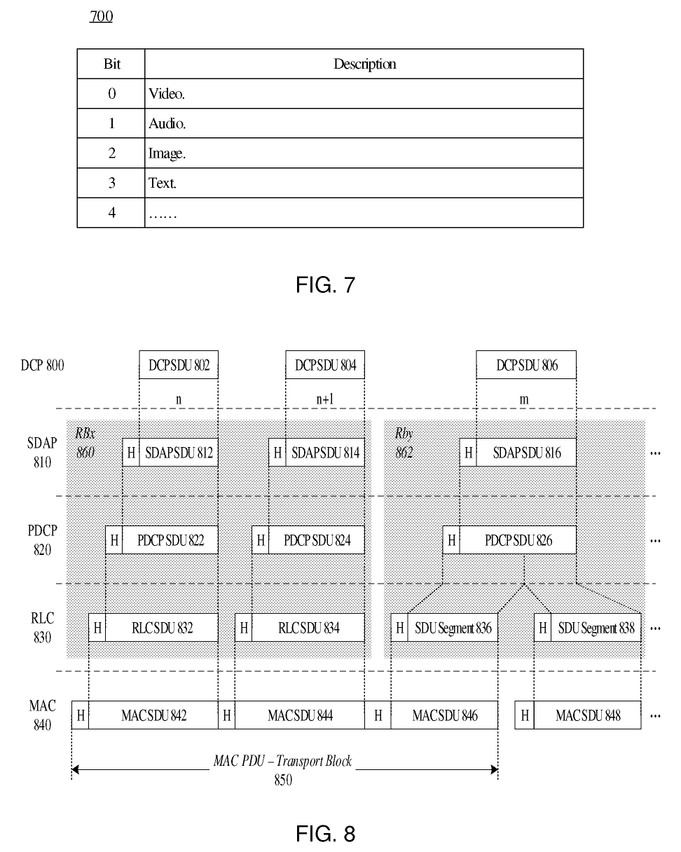

FIG. 7 illustrates a bit field table for a blockchain flow ID (BFI) field, according to an aspect. The bit field table 700 may refer to the BFI field 416 of DCP PDU 400. In some embodiments, the BMI field 414 may have a length of at least 5 bits. In some aspects, the BFI field may indicate application layer information. For example, a block data may include one or more of video, image, text, audio content. In some embodiments, a BFI bit value of 0 may indicate that the block includes video. In some embodiments, a BFI bit value of 1 may indicate that the block includes audio. In some embodiments, a BFI bit value of 2 may indicate that the block includes image. In some embodiments, a BFI bit value of 3 may indicate that the block includes text, and so on.

According to an aspect, the consensus data sent between two network entities in reference to FIG. 17 and 18 may be based on the DCP PDU 400.

FIG. 8 illustrates a Layer 2 data flow of a network node, according to an aspect. As may be appreciate, a packet received by a layer may be referred to a service data unit (SDU) and a packet send by a layer may be referred to a PDU. A layer may process a received SDU including adding a corresponding header to the received SDU to generate the PDU. According to an aspect, the DCP layer 800 may submit one or DCP SDUs 802, 804, and 806 to the SDAP layer 810.

According to an aspect, the SDAP layer 810 may process the received SDUs including adding a header to each of the DCP SDUs to generate corresponding SDAP SDUs (e.g., SDAP SDUs 812 and 814 corresponding to DCP SDUs 802 and 804, respectively, and SDAP SDU 816 corresponding to DCP SDU 806). The SDAP layer 810 may then send the generated SDAP SDUs to the PDCP layer 820.

According to an aspect, the PDCP layer 820 may process the received SDUs including adding a header to each of the SDAP SDUs to generate corresponding PDCP SDUs (e.g., PDCP SDUs 822 and 824 corresponding to SDAP SDUs 812 and 814, respectively, and PDCP SDU 826 corresponding to SDAP SDU 816). The PDCP layer 820 may then send the generated PDCP SDUs to the RLC layer 830.

According to an aspect, the RLC layer 830 may process the received SDUs including adding a header to each of the SDAP SDUs to generate corresponding RCL SDUs (e.g., RLC SDUs 832 and 834 corresponding to PDCP SDUs 822 and 824, respectively. In some aspects, processing the received SDUs may include segmenting the received SDU 826 and adding a header to each segmented SDU to generate RLC SDU segments 836 and 838. The RLC layer 830 may send the generated RLC SDUs 832 and 834 and RLC SDU segments 836 and 838 to the MAC layer 840.

According to an aspect, the SDAP SDUs 812 and 814, PDCP SDUs 822 and 824, and RLC SDUs 832 and 834 may correspond to Resource Block x (RBx) 860, while SDAP SDU 816, PDCP SDU 826 and RLC SDU segments 836 and 838 correspond to Resource Block y (RBy) 862.

The MAC layer 840 may process the received SDUs including adding a header to each SDU to generate corresponding MAC SDUs (e.g., MAC SDUs 842 and 844 corresponding to RLC SDUs 832 and 834, respectively, and MAC SDUs 846 and 848 corresponding to RLC SDU segments 836 and 838 respectively).

In some aspects, the MAC layer 840 may generate a transport block 850 by concatenating two RLC PDUs 832 and 834 from RBx 860 and one RLC PDU (e.g., RLC SDU segment 836) from RBy 862. Each of the two RLC PDUs 832 and 834 from RBx 860 may correspond to a DCP SDU (n and n+1) respectively 802 and 804, while the RLC PDU (e.g., RLC SDU segment 836) from RBy 862 is a segment of the DCP SDU packet (m) (DCP SDU 806.

FIG. 9 illustrates a UE-initiated method for broadcasting blockchain configuration information, according to an aspect. The method 900 may also illustrate a method for joining a group (e.g., a blockchain network). The method 900 includes UE1 921 sending a request message, e.g., a group select request message 901 to xNB1 931. Initially, UE1 may not belong to a group (i.e., to a blockchain network) associated with the blockchain. The group select request message 901 may be a request to join a group associated with a blockchain (the blockchain network). The group select request message 901 may carry blockchain configuration information including one or more of: Player ID, Group ID, Group contract ID, and Read permission and write permission (R/W permission).

The method 900 may further include, the xNB1 931 performing 902 one or more operations such as verifying the ID and group ID of UE1 and updating the parameters (e.g., related configuration information) of UE1. xNB1 may know each UE (including UE1) when said each UE is assigned a player ID. Thus, verifying may involve xNB1 comparing the Player ID with a known database or authentication server to ensure that the Player ID is legitimate and authorized.

The method 900 may further include, the xNB1 931 sending or returning a response, e.g., a group select response 903, to UE1 921. The response message may indicate that xNB1 has verified UE1 for the request (to join the group). The group select response 903 may further indicate the group ID for which UE1 921 has been verified to join (or has joined). The group select response 903 may further indicate the group contract ID associated with the group ID. The group ID and the group contract ID indicated in the group select response 903 may the same as the group ID and the group contract ID in group select request message 901. The method 900 may further include, the xNB1 931 forwarding the request of the Group select request 904 of the UE1 921 to the neighboring base station xNB2 932.

The method 900 may further include, the xNB2 932 performing 905 one or more operations such as verifying the ID and group ID of the UE1 and updating the parameters of the UE1. As may be appreciated, the verifying and updating operations at 905 may be similar to the verifying and updating operations at 902. The method 900 may further include, the xNB2 932 sending or returning a response, e.g., a Group Select Response message 906 (including one or both of Group ID and the Group Contract ID) to the xNB1 931. The method 900 may further include xNB2 932 forwarding the request of the Group select Request 907 of the UE1 to the UE2 922 in the range of the xNB2 932.

The method 900 may further include, after receiving the request 907 from xNB2 932, UE2 922 may return a Group Select Response message 908 to xNB2 932. In some embodiments UE2 922 may update parameters (e.g., related configuration information) of UE1 associated with the blockchain. The Group select Response message 908 may indicate one or both of (the Group ID and the Group contract ID. The method 900 may further include, after receiving the response 908 from UE2 922, xNB2 932 may return a response, e.g., a Group Select Response message 909 to xNB1 931.

According to method 900, one or more of UE1 921, UE2 922, xNB1 931 and xNB2 932 may obtain the blockchain configuration information request of the UE1. In some embodiments, method 900 assumes that UE1 921, UE2 922, xNB1 931 and xNB2 932 already have a trusted alliance. Trusted alliance may indicate that the nodes are part of a same blockchain network. Further, nodes of a same blockchain network are understood to have a trusted alliance. As may be appreciated, trusted alliance may indicate that the nodes (e.g., UE1 921, UE2 922, xNB1 931 and xNB2 932) have agreed to work together and uphold a set of rules and protocols to ensure the security and integrity of the blockchain. Thus, the nodes have established a trust (through a consensus mechanism), which ensures that all participating nodes agree on the state of the blockchain and validity of new transactions.

According to an aspect, one or more control plane operations (e.g., 901-909) involving one or more network entities (UE1 921, UE2 922, xNB1 931 and xNB2 932) in method 900 may be performed at one or more associated DCP layer of the control plane protocol stack.

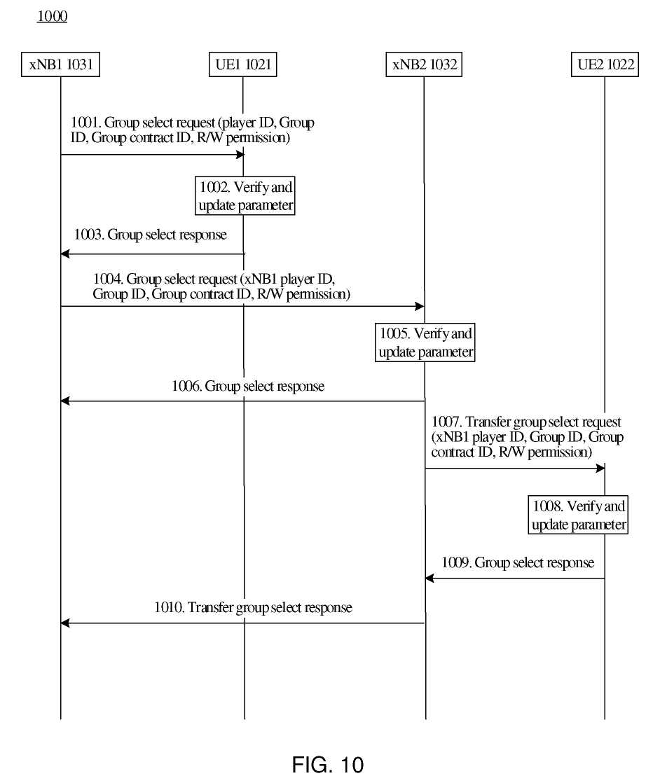

FIG. 10 illustrates an xNB-initiated method for broadcasting blockchain configuration information, according to an aspect. The method 1000 may allow for joining a group (e.g., a blockchain network). The method 1000 includes xNB1 1031 sending a request message, e.g., a Group Select Request message 1001, to UE1 1021. Initially, xNB1 may not belong to a group (i.e., a blockchain). The group select request message 901 may be a request to join a group. The method 1000 may further include xNB1 1031 sending to a neighboring base station xNB2 1032 a Group Select Request message 1004. Each of the Group select Request message 1001 and 1004 may carry information including one or more of: Player ID, Group ID, Group contract, ID, and R/W permission.

The method 1000 may further include, UE1 1021 performing 1002 one or more operations such as verifying the ID and group ID of xNB1 1031 and updating parameters (e.g., related configuration information) of xNB1 1031. UE1 may have knowledge of player IDs permitted to make a request to join a group. Thus, verifying may include comparing the Player ID with IDs in a database or authentication server to ensure that the Player ID is legitimate and authorized.

The method 1000 may further include, UE1 1021 sending or returning a group select response 1003 to xNB1 1031. The group select response may indicate the group ID for which xNB1 has been verified to join (or has joined). The group select response may further indicate the group contract ID associated with the group ID.

The method 1000 may further include, xNB2 1032 performing 1005 one or more operations such as verifying the ID and group ID of xNB1 1031 and updating the parameters of xNB1 1031. As may be appreciated, the verifying and updating operations at 1005 may be similar to the verifying and updating operations at 1002. The method 1000 may further include, xNB2 1032 sending or returning a Group Select Response message 1006 (including one or both of Group ID and the Group Contract ID) to xNB1 1031. The method may further include, xNB2 1032 forwarding the Group select Request 1007 of the xNB1 1031 to the UE2 1022 in the range where the xNB2 is located.

The method 1000 may further include, UE2 1022 performing 1008 one or more operations such as verifying the ID and group ID of xNB1 1031 and updating the parameters of xNB1 1031. As may be appreciated, the verifying and updating operations at 1008 may be similar to the verifying and updating operations at 1002. The method 1000 may further include, after receiving the request from xNB2 1032, UE2 1022 sending or returning a Group Select Response message 1009 (including one or both of Group ID and the Group Contract ID) to xNB2 1032.

The method 1000 may further include, after receiving the response from UE2 1022, xNB2 1032 sending or returning a Group Select Response message 1010 (corresponding to the group select response message 1009 of UE2 1022) to xNB1 1031.

According to method 1000, one or more of UE1 1021, UE2 1022, xNB1 1031 and xNB2 1032 may obtain the blockchain configuration information request of the xNB1 1031. As may be appreciated, in method 1000, two or more of UE1 1021, UE2 1022, xNB1 1031 and xNB2 1032 may have a trusted alliance.

According to an aspect, one or more control plane operations involving one or more network entities (UE1 1021, UE2 1022, xNB1 1031 and xNB2 1032) in method 1000 may be performed at one or more associated DCP layer of the control plane protocol stack.

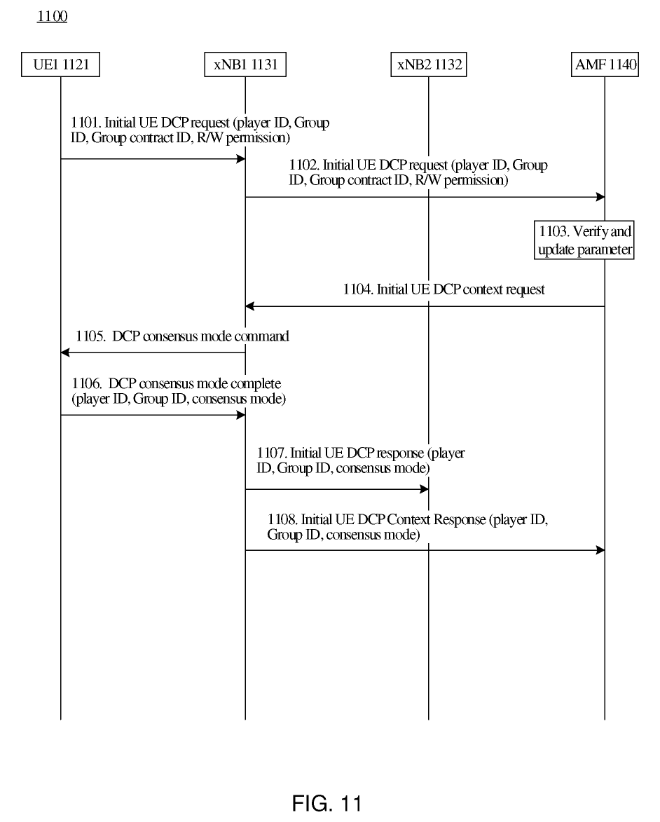

FIG. 11 illustrates a method for verifying an initial access of a blockchain node on the core network, according to an aspect. The method 1100 includes a UE, e.g., UE1 1121, sending a request, e.g., an Initial UE DCP Request message 1101 to xNB1 1131. The Initial UE DCP Request message may be a request for a connection (e.g., a DCP connection) for the node (e.g., UE1 1121) to work as a node on the blockchain identified in the request. The Initial UE DCP Request message 1101 may carry information including one or more of: Player ID, Group ID, Group contract ID, and R/W permission.

The method 1100 may further include, after receiving the request from UE1, xNB1 1131 forwarding the Initial UE DCP Request message 1102 to AMF 1140, which is in the core network. The method 1100 may further includes, AMF 1140 performing 1103 one or more operations such as verifying the ID and group ID of UE1 1121 and updating the parameters of UE1 1121. AMF 1140 may have knowledge of player IDs permitted to request a connection. Thus, verifying may include comparing the Player ID with IDs in a database or authentication server to ensure that the Player ID is legitimate and authorized. The method 1100 may further includes, AMF 1140 sending an Initial UE DCP Context Request message 1104 to xNB1 1131. The Initial UE DCP Context Request message 1104 may request XNB1 1131 to update the context of UE1 1121. DCP context may refer to one or more of: attributes, state, and configuration information needed for establishing and maintaining a connectivity (e.g., DCP connectivity) and communication within the network and group (i.e., blockchain). The Initial UE DCP Context Request message 1104 may request the consensus mode of UE for use on the blockchain.

The method 1100 may further include, xNB1 1131 sending a request message, e.g., a DCP consensus mode command 1105, to UE1 1121. The DCP consensus mode command may indicate to UE1 1121 to configure the consensus mode for use on the blockchain. The consensus mode may be based on the type of blockchain network (e.g., public chain, alliance chain, or private chain). In some aspects, the type of blockchain used in method 1100 may be an alliance chain. Members of alliance chain usually have a high level of trust among themselves which may enable more efficient consensus mechanisms. In some embodiments, configuring a consensus mode may refer to setting up the consensus algorithm or mechanism that will be used by the nodes in the network to reach agreement on the state of the blockchain. There may be various consensus modes or algorithms that can be used in a blockchain network, including proof-of-work, proof-of-stake, delegated proof-of-stake, and others. Each of these mechanisms may have different rules and requirements for nodes to participate and reach consensus.

The method 1100 may further include, after receiving the command for configuring the consensus mode from xNB1, UE1 configuring the consensus mode and returning a response message, e.g., a DCP consensus mode complete message 1106, to xNB1 1131. The DCP consensus mode complete message may carry information including one or more of Player ID, Group ID, and Consensus mode.

The method 1100 may further include, xNB1 1131 sending an Initial UE DCP Response message 1107 to the neighboring xNB2 1132 to notify xNB2 1132 of the consensus mode. The method 1100 may further include, xNB1 1131 sending an Initial UE DCP Context Response message 1108 to AMF 1140. The message 1108 may carry data including Player ID, Group ID, and Consensus mode to notify the AMF of the consensus mode of UE1.

According to method 1100, one or more of UE1 1121, xNB1 1131, xNB2 1132 and AMF 1140 may obtain the consensus information (i.e., consensus mode) of the blockchain of UE1 1121 and select a consensus mode that is the same as that of UE1 1121.

According to an aspect, one or more control plane operations involving one or more network entities (UE1 1121, xNB1 1131, xNB2 1132 and AMF 1140) in method 1100 may be performed at one or more associated DCP layer of the control plane protocol stack.

In some embodiments, core network verification may not be performed. If no core network verification is performed, the initial access of a blockchain node may be performed according to method 1200.

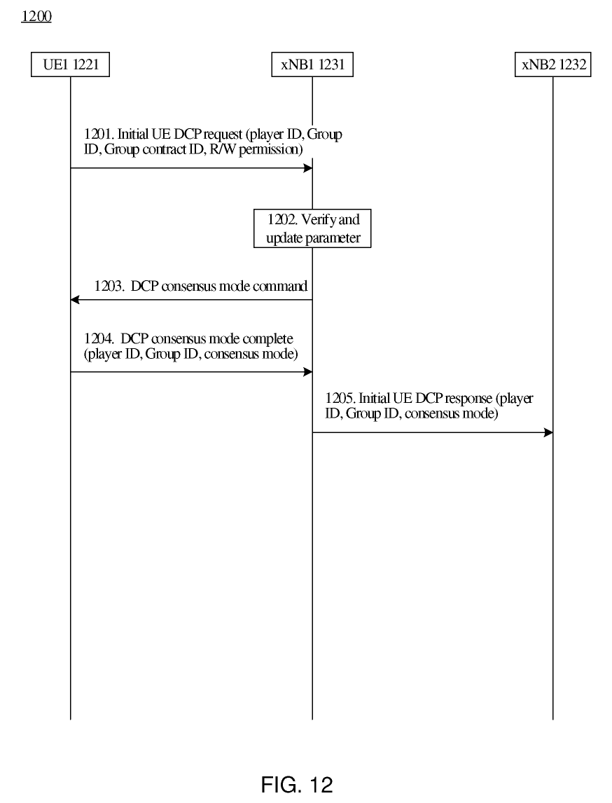

FIG. 12 illustrates a method for verifying an initial access of a blockchain without involving the core network, according to an aspect. The method 1200 includes UE1 1221 sending a request, e.g., an Initial UE DCP Request message 1201, to xNB1 1231. The Initial UE DCP Request message 1201 may be similar to the initial UE DCP request message 1101. The Initial UE DCP Request message may be a request for a connection (e.g., a DCP connection) for the node (e.g., UE1 1221) to work as a node on the blockchain identified in the request. Carry information including one or more of Player ID, Group ID, Group contract, ID, and R/W permission.

The method 1200 may further include, after receiving the request 1201 from UE1, xNB1 1231 performing 1202 one or more operation such as verifying the ID and group ID of UE1 1221 and updating the parameters of UE1. xNB1 may have knowledge of player IDs permitted to request a connection. Thus, verifying may include comparing the Player ID with IDs in a database or authentication server to ensure that the Player ID is legitimate and authorized.

The method 1200 may further include, xNB1 1231 returning or sending a request message, e.g., DCP consensus mode command 1203 to UE1 1221. The DCP consensus mode command 1203 may indicate to UE1 1221 to configure the consensus mode for use on the blockchain. As may be appreciated, the DCP consensus mode command 1203 may be similar to the DCP consensus mode command 1105.

The method 1200 may further include, after receiving the command 1203 for configuring the consensus mode from xNB1 1231, UE1 1221 configuring the consensus mode and returning a response message, e.g., a DCP consensus mode complete message 1204, to xNB1 1231. The DCP consensus mode complete message 1204 may carry information including one or more of Player ID, Group ID, and Consensus mode.

The method 1200 may further include, xNB1 sending a response message, e.g., an Initial UE DCP Response message 1205, to the neighboring xNB2 1232 to notify UE1 of the consensus mode. The Initial UE DCP Response message 1205 may carry information including one or more of Player ID, Group ID, and Consensus mode.

According to method 1200, one or more of UE1 1221, xNB1 1231, and xNB2 1232 may obtain the consensus information (i.e., consensus mode) of the blockchain of the UE1 1221 and select a consensus mode that is the same as that of the UE1 1221.

According to an aspect, one or more control plane operations involving one or more network entities (UE1 1221, xNB1 1231, and xNB2 1232) in method 1200 may be performed at one or more associated DCP layer of the control plane protocol stack.

As may be appreciated, each of methods 1100 and 1200 may be performed to set up or establish the control plane (e.g., the DCP layer at the control plane).

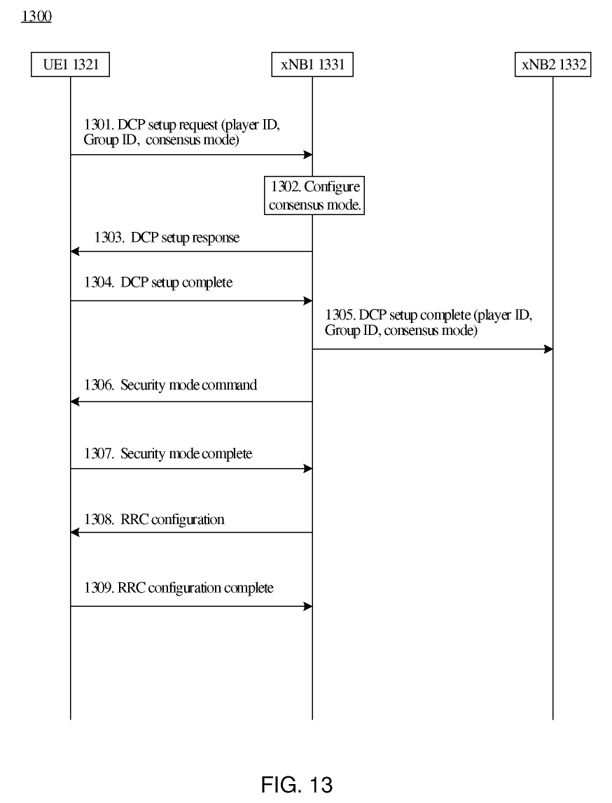

FIG. 13 illustrates a method for establishing a DCP connection on a blockchain node, according to an aspect. The method 1300 may allow a node to connect to a blockchain or a blockchain network. As may be appreciated, method 1300 includes UE1 1321 sending a request, e.g., a DCP setup request message 1301 to xNB1 1331. The request, e.g., DCP setup request message 1301, may be a request to establish, setup, or configure a DCP layer at the user plane. The DCP setup request message 1301 may carry information including one or more of Player ID, Group ID, and Consensus mode. As may be appreciated, the consensus mode may refer to the mechanism by which all nodes or participants in a network come to an agreement on the current state of the blockchain.

The method 1300 may further include xNB1 1331 performing 1302 one or more operations such as such as verifying the ID and group ID of UE1 1321 and updating the parameters of UE1. xNB1 may have knowledge of player IDs permitted to send a request to establish or set up a DCP layer at the user plane. Verifying may include comparing the Player ID with IDs in a database or authentication server to ensure that the Player ID is legitimate and authorized.

xNB1 1331 may further process the request and determining whether to establish a DCP connection. Processing may include xNB1 1331 further configuring the consensus mode. As described herein, the consensus mode may be based on the type of blockchain network (e.g., public chain, alliance chain, or private chain. In some aspects, the type of blockchain used in method 1300 may be an alliance chain. Members of alliance chain usually have a high level trust among themselves which may enable more efficient consensus mechanisms. Further, configuring the consensus mode may be similar to one or more operations performed for configuring a consensus mode as described in one or more aspects herein. The configuring may be based on the received DCP setup request 1301. For example, xNB1 1331 may choose a consensus mode based on the DC setup request message 1301. The method 1300 may further include xNB1 1331 returning a response message, e.g., a DCP setup response message 1303 to UE1 1321. The response message may indicate that the consensus mode is configured (notifying UE1 that xNB1 has chosen a consensus mode based on the DCP setup request message 1301).

After receiving the DCP Setup Response message 1303, the method 1300 may further include, UE1 1321 replying with or sending a response message, e.g., a DCP setup complete message 1304, indicating that the DCP connection is established.

The method 1300 may further include xNB1 1331 notifying neighboring xNB2 1332 that the DCP connection is set up for UE1 1321 by sending a DCP setup complete message 1305 to xNB2 1332. The DCP setup complete message 1305 may include one or more of the Player ID, the Group ID, and the Consensus mode included in the DCP setup request 1301. xNB2 1332 may further configure a consensus mode based on the DCP setup complete message 1305. Configuring the consensus mode may be similar to one or more operations performed for configuring a consensus mode as described in one or more aspects herein.

The method 1300 may further include, xNB1 1331 sending a security mode command message 1306 to UE1 1321. The security mode command message 1306 may include one or more parameters such as the encryption and integrity protection algorithms to be used. In some embodiments, UE1 1321 may process the security mode command message 1306 to determine the appropriate security parameters. The method 1300 may further include, UE1 1321 sending a security mode complete message 1307 to xNB1 1331 to indicate that UE1 1321 is ready to proceed with the security mode.

After receiving the security mode complete message, the method 1300 may further include, xNB1 1331 sending a radio resource control (RRC) configuration message 1308 to UE1 1321. The radio resource control (RRC) configuration message 1308 may include one or more parameters such as frequency band and modulation scheme to be used for the data transmission. The UE1 1321 may process the RRC configuration message 1308 to determine the appropriate radio resource configurations. The method 1300 may further include, UE1 1321 sending an RRC configuration complete message 1309 to xNB1 1331 to indicate that UE1 1321 is ready to establish the radio link. After receiving the RRC configuration complete message 1309, xNB1 1331 may proceed to establish the radio link with the UE1 1321 based on the configured parameters.

As may be appreciated by a person skilled in the art, operations associated with messages 1306 and 1307 relate to security mode and operations associated with messages 1308 and 1309 relate to RRC configuration.

According to an aspect, one or more control plane operations (e.g., messages and operations 1301-1305) involving one or more network entities (UE1 1321, xNB1 1331, and xNB2 1332) in method 1300, may be performed at one or more associated DCP layer of the control plane protocol stack.

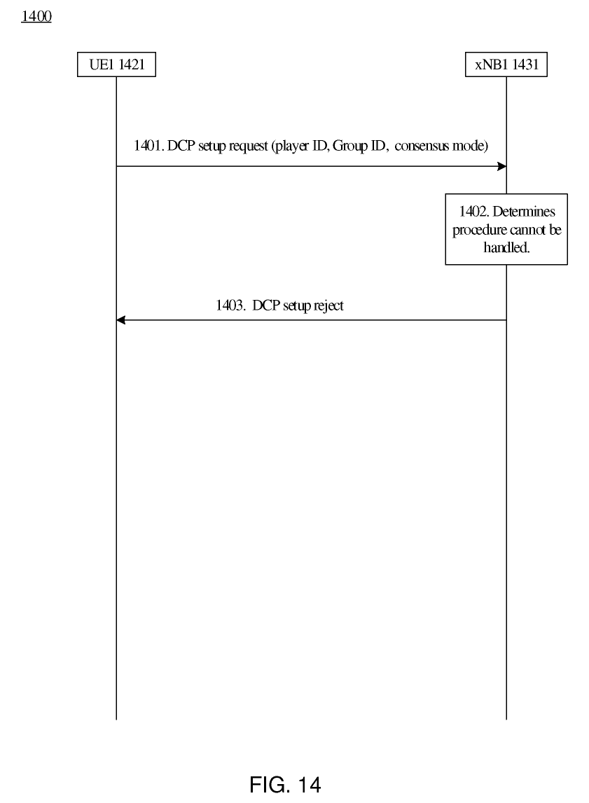

FIG. 14 illustrates a method for rejecting a DCP connection establishment request, according to an aspect. According to an aspect, a request to setup a DCP connection (e.g., DCP setup request 1401) may be rejected based on load balancing, where an xNB may determine that the it cannot handle the request due to high load or congestion on its resources. In an embodiment, the method 1400 illustrates a failure to establish a DCP connection on a blockchain node.

The method 1400 includes, UE1 1421 sending a request, e.g., a DCP setup request message 1404, to xNB1 1431. The request, e.g., DCP setup request message 1401, may be a request to establish or configure a DCP layer at the user plane. The DCP setup request message 1404 may carry information including one or more of Player ID, Group ID, and Consensus mode. The method 1400 may further include, xNB1 1431 performing 1402 one or more operation including processing the request and determining 1402 whether to establish a DCP connection. xNB1 may determine that the DCP setup request procedure cannot be handled due to load balancing, for example. The method 1400 may further include, xNB1 1431 rejecting the request based on load balancing and returning a response message, e.g., DCP setup Reject message 1403 to the UE1 1421.

According to an aspect, one or more control plane operations involving one or more network entities (UE1 1421 and xNB1 1431) in method 1400, may be performed at one or more associated DCP layer of the control plane protocol stack.

As may be appreciated, each of methods 1300 and 1400 may be performed to set up or establish the data or user plane (e.g., the DCP layer at the data or user plane).

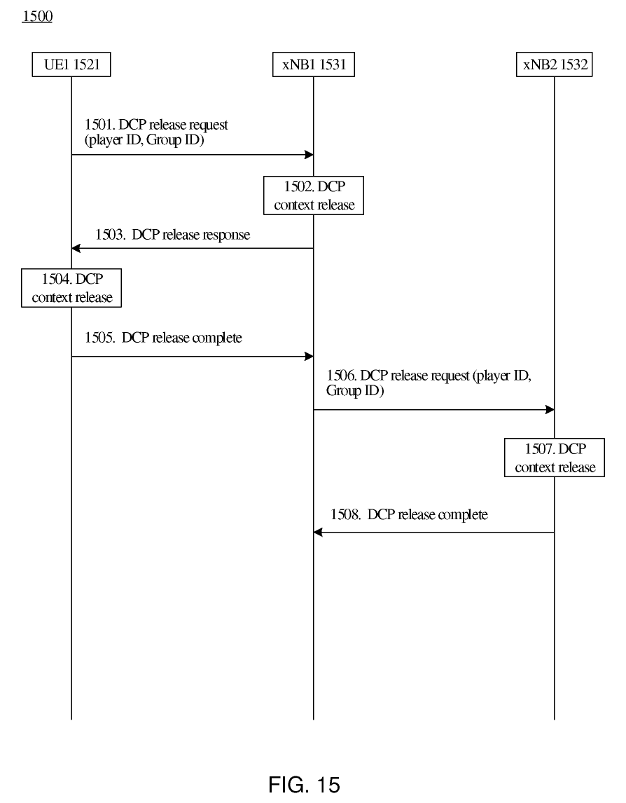

According to an aspect, a network node may be disconnected (e.g., nodes’ connection released) from a blockchain network. FIG. 15 illustrates a UE-initiated method for DCP connection release, according to an aspect. The method 1500 may allow for releasing a connection (e.g., a DCP connection) from a blockchain or blockchain network. The method 1500 includes, UE1 1521 sending a request (or a request message), e.g., a DCP Release Request message 1501, to xNB1 1531. The request, e.g., the DCP Release Request message 1501, may be a request to delete or terminate a connection (e.g., DCP connection) and release the resources associated with the connection. The DCP Release Request message 1501 may carry information including one or more of Player ID and Group ID.

The method 1500 may further include, after receiving the request 1501 from UE1 1521, xNB1 1531 performing 1502 one or more operations such as verifying the ID and group ID of UE1 1521 and releasing the DCP context. xNB1 1531 may have knowledge of player IDs permitted to send a request to release a connection. Verifying may include comparing the Player ID with IDs in a database or authentication server to ensure that the Player ID is legitimate and authorized. Releasing DCP context may involve releasing the resources associated with the DCP connection. The UE context represents the collection of information and parameters specific to a User Equipment (UE) that are relevant to its connectivity and communication with the network. The method 1500 may further include sending, by xNB1 1531, a response message, e.g., DCP release response 1503 to UE1 1521 indicating that the DCP context of UE, at xNB1, is released.

The method 1500 may further include, after receiving a DCP context release response 1503 from xNB1 1531, UE1 1521 releasing 1504 the DCP context. The method 1500 may further include, UE1 1521 returning a response message, e.g., DCP release complete message 1505 to xNB1 1531. The DCP release complete message 1505 may indicate that the DCP context of UE1, at UE1, is released.

The method 1500 may further include, xNB1 1531 sending a DCP release request 1506 to the neighboring xNB2 1532 to release the DCP context of UE1. The DCP release request 1506 may carry information including one or more of player ID and group ID. The method may further include, xNB2 1532 performing one or more operations such as verifying the ID and group ID of UE1 1521 and releasing the DCP context. As described herein, verifying may include comparing the IDs with IDs in a database or authentication server to ensure that the request is legitimate and authorized. Releasing DCP context may involve releasing the resources associated with the DCP connection. The method 1500 may further include, after releasing the DCP context, xNB2 1532 sending a response message, e.g., DCP release response 1508 to xNB1 1531. The DCP release response 1508 may indicate that the DCP context of UE1, at xNB2, is released.

According to an aspect, one or more control plane operations involving one or more network entities (UE1 1521, xNB1 1531, and xNB2 1532) in method 1500, may be performed at one or more associated DCP layer of the control plane protocol stack.

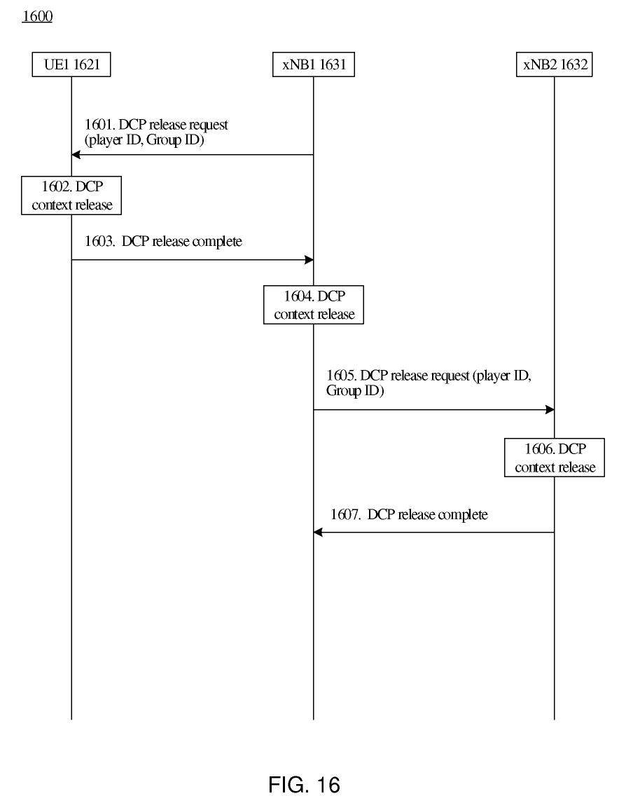

According to an aspect, a DCP connection release procedure may be initiated by the network. FIG. 16 illustrates a network-initiated method for releasing a DCP connection, according to an aspect. The method 1600 may allow for releasing a connection from a blockchain network. The method 1600 includes, xNB1 1631 sending a request, e.g., a DCP release request message 1601, to UE1 1621. The request, e.g., the DCP Release Request message 1601, may be a request to delete or terminate a connection (e.g., DCP connection) and release the resources associated with the connection The DCP release request message 1601 may carry information including one or more of player ID and group ID.

The method 1600 may further include, after receiving the request 1601 from xNB1 1631, UE1 performing 1602 one or more operations such as verifying the ID and group ID of UE1 and releasing the DCP context. The method 1600 may further include, UE1 1621 sending or returning a response message, e.g., a DCP release complete message 1603 to xNB1 1631 indicating the release of DCP context, at UE1.

The method 1600 may further include, after receiving a DCP context release complete message 1603 from UE1 1621, xNB1 1631 releasing the DCP context. Releasing DCP context may involve releasing the resources associated with the DCP connection. The method 1600 may further include, xNB1 1631 sending a request message, e.g., a DCP release request message 1605 to xNB2 1632. The message 1605 may carry information including one or more of the player ID and group ID.

The method 1600 may further include, xNB2 1632 performing one or more operations such as verifying the ID and group ID of UE1 1621 and releasing 1606 the DCP context based on the message 1605. As described herein, verifying may include comparing the IDs with IDs in a database or authentication server to ensure that the request is legitimate and authorized. Releasing DCP context may involve releasing the resources associated with the DCP connection. The method 1600 may further include, after releasing the DCP context, xNB2 1632 notifying xNB1 1631 of the release by sending a response or release complete message, e.g., DCP release complete message 1607. The DCP release complete message 1607 may indicate that the context of UE at xNB2 is released.

According to an aspect, one or more control plane operations involving one or more network entities (UE1 1621, xNB1 1631, and xNB2 1632) in method 1600, may be performed at one or more associated DCP layer of the control plane protocol stack.

According to an aspect, one or more methods may be provided for transmitting block consensus data (e.g., sending data using or on a blockchain via the DCP layer). In some aspects, the block consensus data (or data sent using blockchain) may have a format according to DCP PDU 400. FIG. 17 illustrates a UE-initiated method for transmission of block consensus data, according to an aspect. The method 1700 may allow transmission of data using or on a blockchain, wherein a blockchain node within a network (e.g., blockchain network) transmits data to one or more blockchain nodes within the network. The method 1700 includes, UE1 1721 sending a request, e.g., a consensus request message 1701, to xNB1 1731. The request 1701 may be request to send data or trigger data transmission, and the request being a consensus request indicates that all nodes on the blockchain should agree on the request. The Consensus request message 1701 may carry information including one or more of UE1’s player ID and group ID.

The method 1700 may further include, xNB1 1731 performing 1702 one or more operations such as verifying the ID and group ID of UE1 and updates the parameters of UE1. The method 1700 may further include, xNB1 1731 sending or returning response message, e.g., a Consensus response message 1703 to UE1 1721. The consensus response message 1703 may indicate that xNB1 1731 has verified UE1 1721’s request to send data on the blockchain identified by group ID. The method 1700 may further include, xNB1 1731 forwarding the Consensus request of the UE1 1721 to the neighboring base station xNB2 1732 by sending a request message, e.g., consensus request message 1704, to xNB2 1732. The Consensus request message 1704 may carry information including one or more of UE1’s player ID and group ID. As may be appreciated, the consensus request message 1704 may be sent before sending the consensus response 1703.

The method 1700 may further include, xNB2 1732 performing one or more operations such as verifying the ID and group ID of UE1 and updating the parameters of UE1. The method 1700 may further include, Xnb2 1732 sending or returning a response message, a Consensus response message 1706 to xNB1 1731. The consensus response message 1706 may indicate that xNB2 1732 has verified UE1 1721’s request to send data on the blockchain identified by group ID. xNB1 1731 may forward the consensus response message 1706 of xNB2 to UE1 via sending a consensus response message 1707. The method 1700 may further include, xNB2 1732 forwarding the Consensus request of the UE1 1721 to UE2 1722 in the range of the xNB2 1732 by sending a request e.g., consensus request message 1708. The consensus request message 1708 may include one or more of UE’s player ID and group ID.

The method 1700 may further include, after receiving the request 1707 from xNB2 1732, UE2 1722 may perform 1709 one or more operations such as verifying the ID and group ID of UE1 and updating the parameters of UE1 1721. The method 1700 may further include, UE2 1722 sending or returning a response message, e.g., a Consensus Response message 1710 to xNB2 1732. The consensus response message 1710 may indicate that UE2 1722 has verified UE1 1721’s request to send data on the blockchain identified by group ID. The method 1700 may further include, xNB2 1732 sending the consensus response message 1710 of UE2 1722 to xNB1 1731 by sending a consensus response message 1711 (including the consensus response message 1709). xNB1 1731 may forward the consensus response message 1710 to UE1 via sending a consensus response message 1711.

UE1 1721 may then send consensus data 1712 to xNB1 1731. The consensus data or data sent using blockchain may have a format according to DCP PDUE 400. xNB1 1731 may forward the received consensus data via consensus data 1713 to xNB2 1731, and xNB2 1731 may further forward the received consensus data via consensus data 1714 to UE2 1722. As may be appreciated, in embodiment of FIG. 17, for UE1 1721 to send data (consensus data) via the blockchain (via the DCP layer), all of xNB1 1731, xNB2 1732 and UE2 1722 may need to verify UE1’s request to send data and sent a consensus response. In the case that more entities involved (e.g., xNB3 and UE3), each entity entities may need to receive the consensus request, verify UE1’s request, and send consensus response.

According to an aspect, one or more control plane operations (e.g., messages and operations 1701-1710) involving one or more network entities (UE1 1721, UE2 1722, xNB1 1731, and xNB2 1732) in method 1700, may be performed at one or more associated DCP layer of the control plane protocol stack.

According to an aspect, one or more user plane operations (e.g., consensus data) involving one or more network entities (UE1 1721, UE2 1722, xNB1 1731, and xNB2 1732) in method 1700, may be performed at one or more associated DCP layer of the user plane protocol stack. The consensus data may include one or more DCP PDU 400 according to an aspect.

According to an aspect, transmission of block consensus data may be initiated by an xNB. FIG. 18 illustrates an xNB-initiated method for transmission of block consensus data, according to an aspect. The method 1800 may include xNB1 1831 sending a request, e.g., a consensus request message 1801, to UE1 1821. The request 1801 may be similar to request 1701. The request 1801 may be a request to send data or trigger data transmission, and the request 1801 being a consensus request may require all blockchain nodes to agree on the request (e.g., verify and update parameters). The consensus request message 1801 may carry information including one or more of player ID and group ID of the xNB1.

The method 1800 may further include, UE1 1821 performing 1802 one or more operations such as verifying the ID and group ID of xNB1 and updating the parameters of xNB1. The method may further include, UE1 1821 returning a response message, e.g., Consensus response 1803 to xNB1 1831. The consensus response message 1803 may indicate that UE1 1821 has verified xNB1 1831’s request to send data on the blockchain identified by group ID. The method 1800 may further include, xNB1 sending a request, e.g., Consensus request message 1804 to the neighboring xNB2 1832. The request 1804 may carry information including one or more of the player ID and group ID of the xNB1.

The method 1800 may further include, xNB2 1832 performing 1805 one or more operations such as verifying the ID and group ID of xNB1 and updating the parameters of xNB1. The method 1800 may further include, xNB2 1832 sending a response message, e.g., Consensus response 1806 to xNB1 1831. The consensus response message 1806 may indicate that xNB1 1832 has verified xNB1 1831’s request to send data on the blockchain identified by group ID. The method 1800 may further include, xNB2 1832 forwarding the request of xNB1 via consensus request 1807 to UE2 1822 in the range of the xNB2 1832.

The method 1800 may further include, after receiving the request 1807 from xNB2, UE2 1822 performing 1808 one or more operations such as verifying the ID and group ID of xNB1 and updating the parameters of xNB1. The method 1800 may further include, UE2 1822 sending a response message, e.g., a Consensus Response message 1809 to xNB2 1832. The consensus response message 1809 may indicate that UE2 1822 has verified xNB1 1831’s request to send data on the blockchain identified by group ID. The method 1800 may further include, xNB2 1832 forwarding the consensus response of UE2 1822 via consensus response 1810 to xNB1 1831.

After xNB1 1831 receives the consensus response 1810 from xNB2 1832, xNB1 1831 may send the data using the blockchain (e.g., the consensus data). For example, xNB1 1831 may send consensus data 1811 to UE 1821. The consensus data or data sent using blockchain may have a format according to DCP PDUE 400. xNB1 1831 may further send consensus data 1812 to oxNB2 1832. xNB2 1832 may forward the consensus data 1813 to UE2 1822.

According to an aspect, one or more control plane operations (e.g., messages and operations 1801-1810) involving one or more network entities (UE1 1821, UE2 1822, xNB1 1831, and xNB2 1832) in method 1800, may be performed at one or more associated DCP layer of the control plane protocol stack.

According to an aspect, one or more user plane operations (e.g., consensus data) involving one or more network entities (UE1 1821, UE2 1822, xNB1 1831, and xNB2 1832) in method 1800, may be performed at one or more associated DCP layer of the user plane protocol stack. The consensus data may include one or more DCP PDUs 400 according to an aspect.

According to an aspect, method may be provided for converging a blockchain protocol stack in a communications network. According to one or more aspects, a node in a wireless network may perform one or more processes such as configuration information, protocol establishment, and consensus data exchange by using a protocol stack with a consensus function. According to some aspects, blockchain no longer needs to be used as an external database.

According to an aspect, existing protocols may be enhanced to be compatible with blockchain. According to some aspects, network can directly use the blockchain service by adding sublayers based on the current protocols. According to some aspects, in scenarios where access networks and terminals can be closed, application servers and external blockchains may be not required, thus, the communication path may be shorter.

According to an aspect, an enhanced protocol stack may be provided including a new sub-layer (e.g., DCP sublayer) and data flow integrated into the basic capability of the communication network. The enhanced protocol stack may integrate network and blockchain capabilities and support trustworthiness.

According to an aspect, with the blockchain protocol stack, node communication may not need to be bypassed to application servers or external blockchains, and thus, the communication path may be shorter. Shorter communication path may further allow for lower latency.

According to one or more aspects, one or more methods may be provided for one or more of: Blockchain configuration, initial access and data consensus connection, and release processing. The one or more methods may allow for supporting complicated processing logic and extensibility.

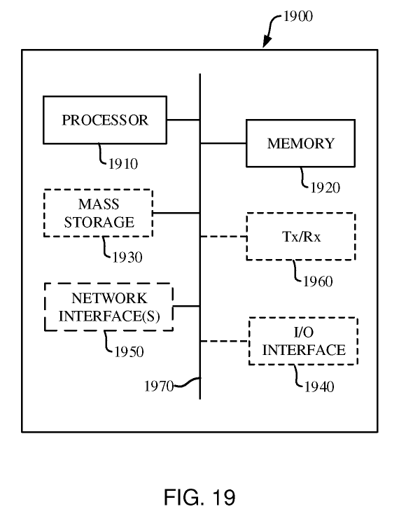

FIG. 19 illustrates an apparatus 1900 that may perform any or all of operations of the above methods and features explicitly or implicitly described herein, according to different aspects of the present disclosure. For example, a computer equipped with network function may be configured as the apparatus 1900. In some aspect, apparatus 1900 can be a device that connects to the network infrastructure over a radio interface, such as a mobile phone, smart phone or other such device that may be classified as user equipment (UE). In some aspects, the apparatus 1900 may be a Machine Type Communications (MTC) device (also referred to as a machine-to-machine (m2m) device), or another such device that may be categorized as a UE despite not providing a direct service to a user. According to an aspect, apparatus 1900 may be a network entity involved in one or more operations or methods described herein. For example, apparatus 1900 may be a network entity, a terminal including a future/6G terminal, a UE including a future UE (xUE), an access node including a future/6G access node (e.g., xNB), a network function (e.g., a core network function such as AMF), and the like. In some aspects, apparatus 1900 may be or configured used to implement one or more aspects described herein. For example, apparatus 1900 may be configured to perform one or more methods according to one or more aspects described herein.

As shown, the apparatus 1900 may include a processor 1910, such as a Central Processing Unit (CPU) or specialized processors such as a Graphics Processing Unit (GPU) or other such processor unit, memory 1920, non-transitory mass storage 1930, input-output interface 1940, network interface 1950, and a transceiver 1960, all of which are communicatively coupled via bi-directional bus 1970. Transceiver 1960 may include one or multiple antennas According to certain aspects, any or all of the depicted elements may be utilized, or only a subset of the elements. Further, apparatus 1900 may contain multiple instances of certain elements, such as multiple processors, memories, or transceivers. Also, elements of the hardware device may be directly coupled to other elements without the bi-directional bus. Additionally, or alternatively to a processor and memory, other electronics or processing electronics, such as integrated circuits, application specific integrated circuits, field programmable gate arrays, digital circuitry, analog circuitry, chips, dies, multichip modules, substrates or the like, or a combination thereof may be employed for performing the required logical operations.

The memory 1920 may include any type of non-transitory memory such as static random-access memory (SRAM), dynamic random-access memory (DRAM), synchronous DRAM (SDRAM), read-only memory (ROM), any combination of such, or the like. The mass storage element 1930 may include any type of non-transitory storage device, such as a solid-state drive, hard disk drive, a magnetic disk drive, an optical disk drive, USB drive, or any computer program product configured to store data and machine executable program code. According to certain aspects, the memory 1920 or mass storage 1930 may have recorded thereon statements and instructions executable by the processor 1910 for performing any of the aforementioned method operations described above.

Aspects of the present disclosure can be implemented using electronics hardware, software, or a combination thereof. In some aspects, this may be is implemented by one or multiple computer processors executing program instructions stored in memory. In some aspects, the application is implemented partially or fully in hardware, for example using one or more field programmable gate arrays (FPGAs) or application specific integrated circuits (ASICs) to rapidly perform processing operations.

It will be appreciated that, although specific aspects of the technology have been described herein for purposes of illustration, various modifications may be made without departing from the scope of the technology. The specification and drawings are, accordingly, to be regarded simply as an illustration of the application as defined by the appended claims, and are contemplated to cover any and all modifications, variations, combinations or equivalents that fall within the scope of the present application. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding aspects, the present application may be implemented by using hardware only or by using software and a necessary universal hardware platform. Based on such understandings, the technical solution of the present application may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the aspects of the present application. For example, such an execution may correspond to a simulation of the logical operations as described herein. The software product may additionally or alternatively include a number of instructions that enable a computer device to execute operations for configuring or programming a digital logic apparatus in accordance with aspects of the present application.

Although the present application has been described with reference to specific features and aspects thereof, it is evident that various modifications and combinations can be made thereto without departing from the application. The specification and drawings are, accordingly, to be regarded simply as an illustration of the invention as defined by the appended claims, and are contemplated to cover any and all modifications, variations, combinations or equivalents that fall within the scope of the present application.

What is claimed is:

1. A method comprising:
sending, by a first entity (FE) to a second entity (SE), a request message to join a group associated with a blockchain, the request message including one or more of: a player identifier (ID) identifying the FE; a group ID identifying the blockchain; a group contract ID identifying a set of instructions to be followed; a read permission; or a write permission; and
receiving, by the FE from the SE, a response message indicating that the FE is verified to join the group, the response message including the group ID and the group contract ID.

2. The method of claim 1, wherein:
sending the request message comprises sending, by the FE to the SE, the request message via a first protocol layer of a control plane protocol stack associated with the FE, the first protocol layer being a data consensus protocol (DCP) layer that supports broadcast of blockchain configuration information; and
receiving the response message comprises receiving, by the FE from the SE, the response message via the DCP layer.

3. The method of claim 1, wherein the FE is a user equipment (UE), and the SE is an access node (AN).

4. The method of claim 1, wherein the FE is a first access node (AN), and the SE is a user equipment (UE), the method further comprising:
sending, by the FE to a second AN, a second request message to join the group associated with the blockchain, the second request message including one or more of: the player ID identifying the FE, the group ID identifying the blockchain, the group contract ID identifying the set of instructions to be followed, the read permission, or the write permission; and
receiving, by the FE from the second AN, a second response indicating that the second AN has verified the FE to join the group.

5. The method of claim 4, wherein the UE is a first UE, the method further comprising:
receiving, by the FE from the second AN, a third response message associated with a second UE and indicating that the second UE has verified the FE.

6. A method comprising:
receiving, by a second entity (SE) from a first entity (FE), a request message to join a group associated with a blockchain, the request message including one or more of: a player identifier (ID) identifying a third entity (TE); a group ID identifying the blockchain; a group contract ID identifying a set of instructions to be followed; a read permission; or a write permission;
verifying, by the SE, one or both of: the player ID or the group ID; and
sending, by the SE to the FE, a response message indicating that the TE is verified to join the group.

7. The method of claim 6, wherein:
receiving the request message comprises receiving, by the SE from the FE, the request message via a first protocol layer of a control plane protocol stack associated with the SE, the first protocol layer being a data consensus protocol (DCP) layer and supporting broadcast of blockchain configuration information; and
sending the response message comprises sending, by the SE to the FE, the response message via the DCP layer.

8. The method of claim 6, wherein either the FE is a user equipment (UE), and the SE is an access node (AN), or the FE is the AN, and the SE is the UE.

9. The method of claim 6, wherein the SE is a first access node (AN), the FE is a user equipment (UE), and the TE is the FE, the method further comprising:
updating, by the SE, one or more parameters of the TE based on the request message;
sending, by the SE to a second AN, a second request message based on the request message, the second request message including one or more of: the player ID, the group ID, the group contract ID, the read permission, or the write permission;
receiving, by the SE from the second AN, a second response message indicating that the second AN has verified the TE to join the group; and
receiving, by the SE from the second AN, a third response message associated with a second UE and indicating that second UE has updated one or more parameters of the TE associated with the blockchain.

10. The method of claim 6, wherein the SE is a first access node (AN) and the FE is a second AN, and the TE is the FE or a first user equipment (UE) the method further comprising:
updating, by the SE, one or more parameters of the TE based on the request message;
sending, by the SE to a second UE, a second request message based on the request message, the second request message including one or more of: the player ID, the group ID, the group contract ID, the read permission, or the write permission;
receiving, by the SE from the second UE, a second response message indicating that the second UE has updated one or more parameters of the TE associated with the blockchain; and
sending, by the SE to the FE, a third response message including the second response message.

11. A system comprising a first entity (FE) and a second entity (SE), wherein:
the FE comprises one or more first processors and one or more first memories, and the one or more first memories store first instructions that, when executed by the one or more first processors, cause the FE to perform first operations comprising:
sending, to the SE, a request message to join a group associated with a blockchain, the request message including one or more of: a player identifier (ID) identifying a third entity (TE); a group ID identifying the blockchain; a group contract ID identifying a set of instructions to be followed; a read permission; or a write permission; and
receiving, from the SE, a response message indicating that the TE is verified to join the group, the response message including the group ID and the group contract ID; and
the SE comprises one or more second processors and one or more second memories, and the one or more second memories store second instructions that, when executed by the one or more second processors, cause the SE to perform second operations comprising:
receiving, from the FE, the request message;
verifying one or both of: the player ID or the group ID; and
sending, to the FE, the response message.

12. The system of claim 11, wherein the first operations further comprise:
sending the request message to the SE via a first protocol layer of a control plane protocol stack associated with the FE, the first protocol layer being a data consensus protocol (DCP) layer that supports broadcast of blockchain configuration information; and
receiving the response message from the SE via the DCP layer.

13. The system of claim 11, wherein the FE is a first access node (AN), the SE is a user equipment (UE), and the first operations further comprise:
sending, to a second AN, a second request message to join the group associated with the blockchain, the second request message including one or more of: the player ID identifying the FE, the group ID identifying the blockchain, the group contract ID identifying the set of instructions to be followed, the read permission, or the write permission; and
receiving, from the second AN, a second response indicating that the second AN has verified the FE to join the group.

14. The system of claim 13, wherein the UE is a first UE, and the first operations further comprise:
receiving, from the second AN, a third response message associated with a second UE and indicating that the second UE has verified the FE.

15. The system of claim 11, wherein the second operations further comprise:
receiving the request message from the FE via a first protocol layer of a control plane protocol stack associated with the SE, the first protocol layer being a data consensus protocol (DCP) layer and supporting broadcast of blockchain configuration information; and
sending the response message to the FE via the DCP layer.

16. The system of claim 11, wherein the SE is a first access node (AN), the FE is a user equipment (UE), the TE is the FE, and the second operations further comprise:
updating one or more parameters of the TE based on the request message;
sending, to a second AN, a second request message based on the request message, the second request message including one or more of: the player ID, the group ID, the group contract ID, the read permission, or the write permission;
receiving, from the second AN, a second response message indicating that the second AN has verified the TE to join the group; and
receiving, from the second AN, a third response message associated with a second UE and indicating that second UE has updated one or more parameters of the TE associated with the blockchain.

17. The system of claim 11, wherein the SE is a first access node (AN), the FE is a second AN, the TE is the FE or a first user equipment (UE), and the second operations further comprise:
updating one or more parameters of the TE based on the request message;
sending, to a second UE, a second request message based on the request message, the second request message including one or more of: the player ID, the group ID, the group contract ID, the read permission, or the write permission;
receiving, from the second UE, a second response message indicating that the second UE has updated one or more parameters of the TE associated with the blockchain; and
sending, to the FE, a third response message including the second response message.

18. The system of claim 11, wherein the FE is a user equipment (UE), the SE is a first access node (AN), the TE is the FE, and the second operations further comprise:
sending, to a second AN, a second request message to join the group associated with the blockchain, the second request message including one or more of: the player ID identifying the FE, the group ID identifying the blockchain, the group contract ID identifying the set of instructions to be followed, the read permission, or the write permission;
receiving, from the second AN, a second response indicating that the second AN has verified the TE to join the group; and
receiving, from the second AN, a third response message associated with a second UE and indicating that the second UE has verified the TE.

19. The system of claim 11, wherein:
the FE is an access node (AN), the SE is a user equipment (UE), and the TE is the FE; and
the first operations further comprise:
sending, to a second AN, a second request message to join the group associated with the blockchain, the second request message including one or more of: the player ID, the group ID identifying the blockchain, the group contract ID identifying the set of instructions to be followed, the read permission, or the write permission;
receiving, from the second AN, a second response indicating that the second AN has verified the TE to join the group; and
receiving, from the second AN, a third response message associated with a second UE and indicating that the second UE has verified the TE.

20. The system of claim 11, wherein:
the FE is a first access node (AN), the SE is a second AN, and the TE is the FE or a first user equipment (UE);
the second operations further comprise:
sending, to a second UE, a second request message based on the request message, the second request message including one or more of: the player ID, the group ID, the group contract ID, the read permission, or the write permission;
receiving, from the second UE, a second response message indicating that the second UE has verified the TE to join the group; and
sending, to the FE, a third response message including the second response message; and
the first operations further comprise:
receiving, from the SE, the third response message.
